(19) United States
(12) Patent Application Publication
(10) Pub. No.: US 2002/0108478 A1
(43) Pub. Date: Aug. 15, 2002

(54) Apparatus and method for slotting a pipe

(75) Inventors: Brian Klimack, Edmonton (CA); Raymond C. Labonte, St. Albert (CA)

Correspondence Address: RODMAN RODMAN, 7 SOUTH BROADWAY, WHITE PLAINS, NY, 10601

(73) Assignee: Slotwell Ltd., Nisku (CA)

(21) Appl. No.: 10/028,593

(22) Filed: Dec. 20, 2001

Related U.S. Application Data
(63) Continuation-in-part of application No. 09/117,251, filed on Jul. 21, 1998, now abandoned.
(60) Provisional application No. 60/011,260, filed on Feb. 7, 1996.

(30) Foreign Application Priority Data
Feb. 7, 1998 (CA) PCT/CA97/00085

(51) Int. Cl. B26D 1/12; B26D 7/02

(52) U.S. Cl. 83/54; 83/452; 83/485

(57) ABSTRACT

A method and apparatus for slotting a pipe including a clamping system comprising a clamping surface adapted to engage at least about 50 percent of the pipe circumference and at least about 50 percent of the pipe length in a clamped position and which defines a longitudinal clamping gap oriented to permit the slotting of the pipe therethrough. A first perforating mechanism moves a cutting head comprised of a plurality of cutters toward and away from the clamping gap such that the cutters perforate the pipe wall. A second independently operable longitudinal cutting mechanism moves the cutting head along the clamping gap to further cut the pipe wall by the cutters to form a plurality of discrete slots. A third indexing mechanism rotates the pipe about its longitudinal axis in an unclamped position to vary the location of contact between the cutters and the pipe wall about the pipe circumference.

### FIELD OF INVENTION

The present invention relates to an apparatus and a method for slotting a pipe to form at least one slot therein, wherein the apparatus and the method provide improved clamping of the pipe during slotting such that the dimensions and configuration of the slots formed in the pipe may be more closely controlled. Preferably, the pipe is for use in the production of oil from formations that contain heavy oil or tar sands.

### BACKGROUND OF INVENTION

In tar sands and heavy oil recovery, a pipe, being a casing, tubing or other liner, is typically installed in a wellbore for production of oil from an underground formation or producing zone. The pipe is preferably perforated or slotted about its circumference before placement in the wellbore. The desired length and width of the slots perforated in the pipe and the desired number of slots depend upon various factors, including the granular size of any sand in the formation, the minimum strength and integrity of the pipe required for the particular application or use of the pipe and the rate of the oil/sand influx into the pipe.

Further, the slots may be straight or keystone. A straight slot has the same slot width on the inside and outside diameter of the pipe. A straight slot is used when sand control is not a major concern or the sand granular size is relatively large. The keystone slot has a larger width slot on the inside diameter, than on the outside diameter, of the pipe. The keystone slot is used when plugging of the slot from sand is a concern. The outside diameter of the slot controls the sand granular size permitted to enter the pipe, while the larger inside diameter permits the sand to pass from the slot into the pipe.

Various apparatuses and methods have been developed for slotting pipe for use in the production of oil. For instance, U.S. Pat. No. 1,760,075 issued May 27, 1930 to McCullough et al is directed at a machine for cutting or forming an “improved perforation” in a pipe having “inwardly divergent side walls and inwardly convergent end walls”, often referred to as a keystone slot. The machine is comprised of a frame, a pipe carriage carried by the frame, a pipe rack mounted on a carriage head and which is also carried by the frame, a plurality of blades carried by the head, and operating means for the blades. Keystone slots are cut in a single row in the casing by rotating the pipe rack about the top dead centre axis of the pipe.

In McCullough et al, the pipe to be perforated is secured in the machine by placing it in a pipe rack, which includes an elongate body and a plurality of V-shaped pipe holders, and engaging a pivoting arm against the surface of the pipe. A plurality of cutter units carried by a carriage head are then moved downwardly so that the cutter units engage the uppermost portion of the pipe referred to as the longitudinal pivotal axis of the pipe. The cutter blades of the cutter units are fed into the pipe for the desired distance and then withdrawn from the pipe. Thus, the depth or distance of penetration of the cutter blade into the pipe is determinative of the length of the perforation or slot formed therein. Subsequently, the pipe is rotated about the longitudinal pivotal axis of the pipe, followed by repeating the movement of the carriage head downwardly in the manner described above. Thus, the cutting action is performed by a single cutting motion, being the movement of the cutter units downward vertically into the pipe for a desired distance.

U.S. Pat. No. 2,629,920 issued Mar. 3, 1953 to Pridy is also directed at a machine for perforating pipe. The pipe is supported on a cradle comprised of opposed inclined members during the slotting operation. More particularly, a roller is positioned in the trough formed by the opposed inclined members of the cradle for supporting the pipe thereon.

Further, the machine of Pridy provides for a cutter head, comprised of a series of metal saws, to be held rigidly while causing the pipe to be perforated to move toward and away from the cutter head as the slotting operation takes place. Specifically, the pipe is movable vertically towards and away from the cutter head for perforation by the metal saws to slit the pipe, while being restrained from horizontal movement. Thus, the depth or distance of penetration of the metal saws into the pipe is solely determinative of the length of the perforation or slot formed therein. The cutting action is performed by a single cutting motion, being the movement of the pipe upward vertically toward the cutting head for a desired distance.

German Patent Application No. DE 32 13 464 A1 published Apr. 10, 1983 by Schaubstahl-Werke relates to a slotting device which includes a sliding carriage having two bearing pedestals that contain one rotatable chuck each. The casing is held in position between the frontal surfaces of the chucks of the bearing pedestals on the sliding carriage such that the chucks permit the casing to be rotated about its longitudinal axis.

The slotting tools, which are preferably buzz saws, are moved vertically into contact with the casing to cut the slot therein. The length of each individual longitudinally slotted hole depends upon the depth of penetration of the buzz saw into the casing. Once the preset depth of penetration of the buzz saw is reached, the saw is retracted from the casing. The sliding carriage is then moved horizontally in order to move the casing into a different position for the next cutting motion. Thus, the length of the slots to be cut in the casing is determined by the diameter of the cutting blade of the buzz saws.

U.S. Pat. No. 3,209,632 issued Oct. 5, 1965 to Reising is directed at two embodiments of a slotting device. In a first embodiment, the casing or pipe moves over and in contact with a carriage-cam wheel which is rotatably mounted on a horizontal shaft. More particularly, the pipe is disposed in a groove defined by the carriage-cam wheel. A single cutter is rockably mounted above the carriage-cam wheel and is supported at its forwardmost end by a cam follower which has a roller disposed on its lower end. The roller of the cam follower is in contact with and may roll along a camming surface of the carriage-cam wheel.

In a second embodiment of Reising, the pipe or casing lies within a trough formed for that purpose in a longitudinal carriage having an upper camming surface and which operates similarly to that of the carriage-cam wheel of the first embodiment. The longitudinal carriage is slidable in a horizontal direction.

In operation, the pipe or casing moves over the carriage-cam wheel of the first embodiment, or within the longitudinal carriage of the second embodiment, causing the camming surface to movably engage the cam roller. The engagement of the roller with the camming surface raises and lowers the single cutter out of and into contact with the casing. In particular, the cam roller rides upon a first ramped portion of the camming surface which gradually lowers the cutter into contact with the casing. The cam roller then rides into a depressed portion of the camming surface, during which time the cutter continues to cut the casing. When the cam roller rides upon a second ramped portion of the camming surface, the cutter is raised out of contact with the casing and the cutting motion for that slot is completed.

Conventional apparatuses for slotting pipe, such as those described above, typically include a cutting head which is comprised of a number of blades or circular saws. These blades are moved through the casing to create the slot in a manner such that the length of the slot is determined by the diameter of the cutting blade. As the diameter of the blade is increased, in order to lengthen the slot, blade stability may decrease, which may result in greater blade breakage, less control over any slot width deviation, decreased cutting speeds and an inability to cut slots having relatively smaller slot widths. Accordingly, the length of the slot that can be cut in the casing by a conventional slotting apparatus may be limited. As well, the precision with which the slot may be cut may also be limited resulting in decreased control over the slot configuration and dimensions.

Further, conventional apparatuses for slotting pipe, such as those described above, provide limited clamping or securing of the pipe by the apparatus during the slotting operation. As a result, the precision with which the slot may be cut may again be adversely affected. To cut a more precise slot, it is desirable that the pipe be securely maintained in a desired position during the slotting operation. However, as discussed above, many apparatuses do not provide any means or mechanism, or provide an insufficient or unsatisfactory means or mechanism, for securing the pipe with the apparatus. As result, unwanted vibration or movement of the pipe occurs during the slotting operation.

There is therefore a need in the industry for an apparatus and a method for slotting a pipe which permit relatively greater control and precision with respect to the dimensions of each slot and the configuration or pattern of the slots cut in the pipe, as compared to conventional slotting apparatuses and methods. Further, there is a need for a method and an apparatus which provide improved clamping or securing of the pipe during slotting of the pipe in order to improve the precision with which the slots may be cut. In addition, when utilizing blades to perforate the pipe, there is a need for a method and an apparatus wherein the length of the slots cut by the apparatus and the method are preferably not limited or solely determined by the diameter of the blades.

### SUMMARY OF INVENTION

The present invention relates to an apparatus and a method for slotting a casing or pipe which permit relatively greater control over, and relatively greater flexibility and variation with respect to, the length and width of the slots cut in the casing, as compared to conventional slotters. Further, the invention relates to an apparatus and a method for slotting a pipe which may permit the length of the slot to be varied, while maintaining a desired width of the slot. More particularly, the apparatus and the method may permit relatively longer slot lengths, and relatively narrower slot widths, to be cut in conventional casing as compared to slots cut by conventional slotters. When blades are used in the apparatus and method to cut the pipe, the length of the slots are preferably not limited or solely determined by the diameter of the blades used. Finally, the invention relates to an apparatus which may permit the full length or entire joint of the pipe to be slotted by a row of slots in a single process or operation.

In an apparatus aspect, the invention is an apparatus for slotting a pipe, the pipe having a pipe length, a pipe wall and a pipe longitudinal axis, the pipe wall having a pipe external surface defining a pipe circumference, the apparatus comprising:

(a) a stationary pipe bed for supporting the pipe, the pipe bed having a pipe bed length;

(b) a clamping system associated with the pipe bed and having a clamp length, the clamping system being movable between a clamped position for releasably securing the pipe to the pipe bed and an unclamped position, wherein the clamping system is comprised of a clamping surface adapted to engage in the clamped position at least about 50 percent of the pipe circumference and at least about 50 percent of the pipe length, and wherein the clamping system in the clamped position defines a longitudinal clamping gap extending along the clamp length which is oriented to permit the slotting of the pipe therethrough;

(c) a movable cutting head located adjacent to the pipe bed, the cutting head comprising a plurality of cutters for slotting the pipe, the cutters linearly arranged along the cutting head in a row substantially parallel to the longitudinal clamping gap;

(d) a first perforating mechanism for moving the cutting head toward and away from the longitudinal clamping gap such that the pipe wall is perforated by the cutters through the longitudinal clamping gap at a location of contact between the cutters and the pipe wall;

(e) a second longitudinal cutting mechanism, operable independently from the first perforating mechanism, for moving the cutting head longitudinally relative to the pipe bed along the longitudinal clamping gap such that the perforated pipe wall is further cut by the cutters through the longitudinal clamping gap to form a plurality of discrete slots, each of the slots having a slot length; and

(f) a third indexing mechanism for rotating the pipe about the pipe longitudinal axis when the clamping system is in the unclamped position, in order to vary the location of contact between the cutters and the pipe wall about the pipe circumference.

In a method aspect, the invention is a method for slotting a pipe, the pipe having a pipe length, a pipe wall and a pipe longitudinal axis, the pipe wall having a pipe external surface defining a pipe circumference, the method comprising the steps of:

(a) positioning the pipe on a stationary pipe bed;

(b) moving a clamping system associated with the pipe bed to a clamped position to releasably secure the pipe to the pipe bed, the clamping system comprising a clamp length and a clamping surface, such that the clamping surface engages at least about 50 percent of the pipe circumference and at least about 50 percent of the pipe length, and such that the clamping system defines a longitudinal clamping gap extending along the clamp length which is oriented to permit the slotting of the pipe therethrough;

(c) providing a movable cutting head at a location adjacent to the pipe bed, the cutting head comprising a plurality of cutters for slotting the pipe, the cutters linearly arranged along the cutting head in a row substantially parallel to the longitudinal clamping gap;

(d) first moving the cutting head in a direction toward the longitudinal clamping gap to move the cutters into engagement with the pipe wall such that the pipe wall is perforated by the cutters through the longitudinal clamping gap at a location of contact between the cutters and the pipe wall;

(e) second moving the cutting head longitudinally relative to the pipe bed along the longitudinal clamping gap, wherein the second moving step is performed independently from the first moving step and in sequence following the first moving step, such that the perforated pipe wall is further cut by the cutters through the longitudinal clamping gap to form a first plurality of discrete slots, each of the slots having a length;

(f) third moving the cutting head away from the longitudinal clamping gap so that the cutters are moved out of engagement with the pipe wall;

(g) moving the clamping system to an unclamped position from the clamped position;

(h) rotating the pipe about the pipe longitudinal axis; and

(i) repeating steps (a) through (f) to form a second plurality of discrete slots, wherein the first plurality of discrete slots and the second plurality of discrete slots are spaced circumferentially about the pipe circumference.

As indicated, the pipe bed has a pipe bed length. The pipe bed length may be any length which is capable of supporting the pipe without undue movement or sagging of the pipe. The pipe bed may provide for either continuous or intermittent support of the pipe along the pipe bed length. Preferably, however, the pipe bed length is about as long as the pipe length or greater and provides for substantially continuous support of the pipe along the pipe bed length so that the pipe is supported by the pipe bed substantially continuously along substantially its entire length.

As indicated, the clamping system has a clamp length. The clamp length is the overall length of the clamping system. The clamp length may be shorter, longer or the same length as the pipe bed length. Preferably, however, the clamp length is such that it extends along substantially the entire pipe length when the pipe is supported on the pipe bed.

An important feature of the invention is the extent to which the clamping surface engages the pipe external surface when the clamping system is in the clamped position. The clamping surface must engage at least about 50 percent of the pipe circumference in the clamped position in order to distribute the clamping force exerted by the clamping system and in order to provide a relatively positive engagement between the clamping surface and the pipe wall.

Preferably, however, the clamping surface engages more than 50 percent of the pipe circumference in the clamped position. In the preferred embodiment the clamping surface engages between about 70 percent and about 90 percent of the pipe circumference in the clamped position, depending upon the size of the pipe which is being clamped. The clamping surface may, however, engage more than 90 percent of the pipe circumference. The only upper limit of the extent to which the clamping surface may engage the pipe circumference is that the clamping system must provide a suitable width of longitudinal clamping gap along the clamp length for facilitating cutting of the slots in the pipe.

The clamping surface must engage at least about 50 percent of the pipe length in order to distribute the clamping force exerted by the clamping system and in order to provide a relatively positive engagement between the clamping surface and the pipe wall. Preferably the clamping surface is configured so that it extends either continuously or intermittently along substantially the entire clamp length. As a result, there may be transverse gaps or spaces in the clamping surface along the clamp length as long as the clamping surface engages at least about 50 percent of the pipe length.

Preferably, however, the clamping surface engages more than 50 percent of the pipe length in the clamped position. In the preferred embodiment the clamping surface engages at least about 70 percent of the pipe length in the clamped position. The clamping surface may, however, engage as much as 90 percent or even 100 percent of the pipe length in the clamped position.

In the preferred embodiment the clamping system is comprised of a plurality of clamps which collectively comprise the clamping surface. The plurality of clamps are longitudinally spaced along the clamp length for engaging the pipe circumference in the clamped position. The plurality of clamps may be configured to provide for continuous or intermittent clamping along the pipe length. Preferably the clamps are separated longitudinally so that there are transverse gaps between the clamps, thus reducing the likelihood of interference between adjacent clamps. Preferably, however, the size of these gaps is minimized in order to maximize the amount of the pipe length which is engaged by the clamping surface. In the preferred embodiment the size of the gaps between adjacent clamps is in the order of several inches, preferably about two inches (5.08 cm).

The clamping system may comprise any structure or apparatus which is capable of moving between the clamped position and the unclamped position and which is capable of providing the minimum required engagement of the clamping surface about the pipe circumference and along the pipe length.

In the preferred embodiment, each clamp is comprised of a pair of clamp arms, which clamp arms define the longitudinal clamping gap between them when they are in the clamped position. At least one of the clamp arms is movable relative to the other clamp arm so that the clamp can be moved between the clamped position and the unclamped position.

The clamping system may be powered by any type of power system, including electric, mechanical, pneumatic and hydraulic systems. In the preferred embodiment the clamping system is powered by a hydraulic system and the clamping system is further comprised of at least one hydraulic cylinder which may be actuated to move the clamping system between the clamped position and the unclamped position.

The first perforating mechanism may be comprised of any structure or apparatus which is operable to move the cutting head relative to the pipe bed in order to bring the cutters into and out of engagement with the pipe wall. Preferably the first perforating mechanism is comprised of a mechanism which is capable of providing relatively precise control over the movement of the cutting head in order to avoid or minimize cutter blade breakage. The use of a worm or screw jack type-apparatus as a component of the first perforating mechanism has been found to be advantageous in this regard.

In the preferred embodiment, the first perforating mechanism is comprised of:

(a) a movable frame for supporting the cutting head adjacent to the pipe bed such that the row of cutters is movable towards and away from the longitudinal clamping gap in order to move the cutters into and out of contact with the pipe wall;

(b) a carriage for supporting the movable frame, wherein the carriage is movable longitudinally relative to the pipe bed and wherein the carriage is associated with the movable frame such that longitudinal movement of the carriage relative to the pipe bed is translated into movement of the cutters either towards or away from the longitudinal clamping gap; and

(c) a gear assembly comprised of a rack and worm, wherein the rack is operatively connected with the carriage such that rotation of the worm moves the carriage longitudinally relative to the pipe bed.

The second longitudinal cutting mechanism may be comprised of any structure or apparatus which is operable to move the cutting head longitudinally relative to the pipe bed in order to form the plurality of discrete slots which each have a slot length. Preferably the second longitudinal cutting mechanism is comprised of a mechanism which is capable of providing relatively precise control over the longitudinal movement of the cutting head in order that the slot length can be controlled and in order that cutter blade breakage can be avoided or minimized. The use of a worm or screw jack type-apparatus as a component of the second longitudinal cutting mechanism has been found to be advantageous in this regard.

In the preferred embodiment the second longitudinal cutting mechanism is comprised of a rack and worm gear assembly, wherein the rack is operatively connected with the cutting head such that rotation of the worm moves the cutting head relative to the pipe bed along the longitudinal clamping gap.

The third indexing mechanism may be comprised of any structure or apparatus which is operable to rotate the pipe about the pipe longitudinal axis in order to vary the location of contact between the cutters and the pipe wall about the pipe circumference. Preferably the third indexing mechanism is comprised of a mechanism which is capable of providing relatively precise control over the rotation of the pipe so that careful control over the positions of the locations of contact between the cutters and the pipe wall can be maintained, thus enabling the apparatus to cut precise slot configurations in the pipe wall. The use of a worm or screw jack type-apparatus as a component of the third indexing mechanism has been found to be advantageous in this regard.

In the preferred embodiment, the third indexing mechanism is comprised of:

(a) a rotatable head for releasably securing the pipe such that rotation of the rotatable head rotates the pipe about the pipe longitudinal axis, wherein the rotatable head is comprised of a gear wheel; and

(b) a worm operatively associated with the gear wheel such that rotation of the worm actuates the gear wheel to rotate the rotatable head.

The apparatus and method of the present invention therefore provide a precision system which is capable of maintaining precise control over a pipe slotting procedure, thus enabling the cutting of slot configurations which have previously been difficult to attain while minimizing losses and downtime associated with cutter blade breakage.

### SUMMARY OF DRAWINGS

Embodiments of the invention will now be described with reference to the accompanying drawings, in which:

FIG. 1 is an end view of a preferred embodiment of the apparatus, showing a cutting head and pipe bed of the apparatus;

FIG. 2 is a side view of the apparatus taken along lines 2-2 of FIG. 1, wherein the pipe bed has been removed;

FIG. 3 is a pictorial back view of a clamp comprising a clamping system of the pipe bed, wherein the clamp has a break-away portion showing a portion of the pipe therein;

FIG. 4 is a pictorial front view of the clamp shown in FIG. 3, showing a clamp linkage mechanism;

FIG. 5 is an end view of the clamp shown in FIG. 3, wherein the clamping system is in a clamped position;

FIG. 6 is an end view of the clamp shown in FIG. 3, wherein the clamping system is in an unclamped position;

FIG. 7 is a pictorial front side view of a cutting box of the cutting head of the apparatus as shown in FIGS. 1 and 2;

FIG. 8 is a pictorial back side view of the cutting box shown in FIG. 7;

FIG. 9 is an exploded longitudinal section of a front end of a spindle of the cutting box shown in FIG. 7;

FIG. 10 is a schematic diagram of a pulley system of the cutting box shown in FIG. 7;

FIG. 11 is an end view of an indexing mechanism of the apparatus including a hollow spindle chuck; and

FIG. 12 is a pictorial view of the indexing mechanism shown in FIG. 11 having the hollow spindle chuck removed therefrom.

### DETAILED DESCRIPTION

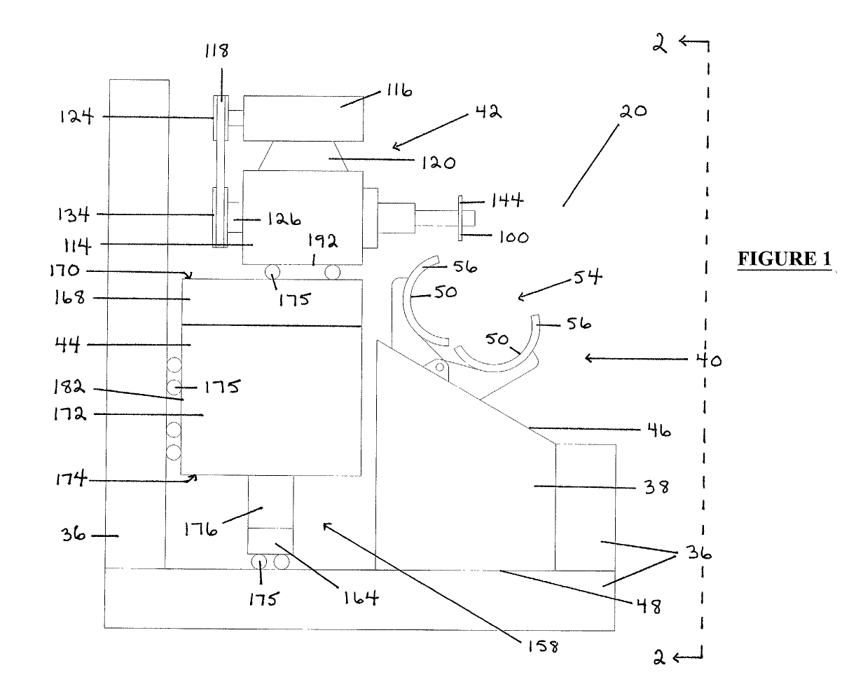

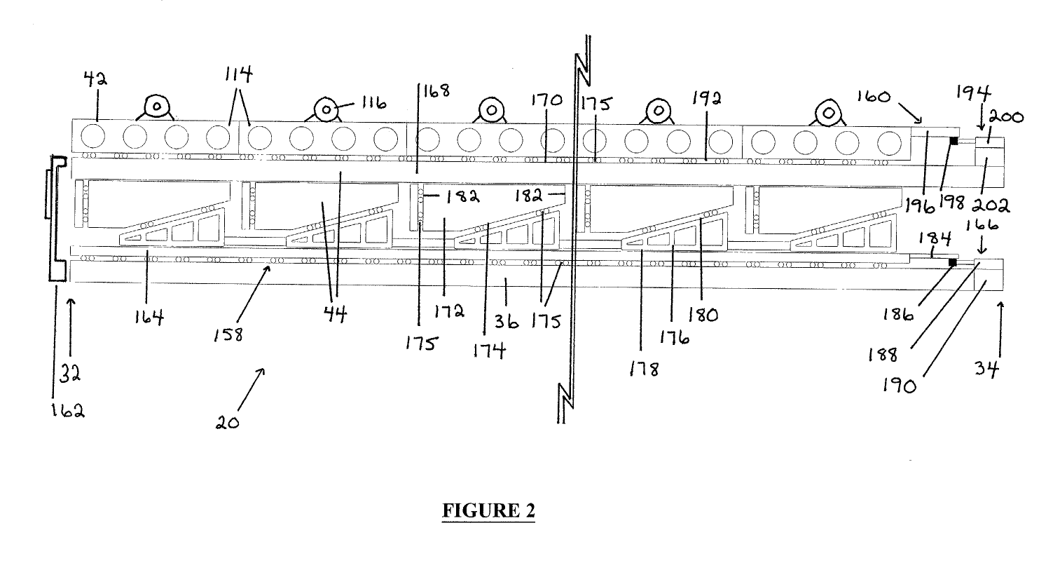

Referring to FIGS. 1 and 2, the invention is directed at an apparatus (20), and an associated method, for slotting a length of a pipe (22) or conduit at a desired location. Preferably, the invention is used for slotting pipe to be used for the production of oil through a wellbore from an underground formation or producing zone. Thus, the pipe (22) will preferably be comprised of a casing, tubing or other liner to be installed in the wellbore such that the oil is produced, or brought to the surface, through the casing, tubing or liner. However, this invention may be used for slotting pipe required for any use or application. Further, the invention may be used for slotting any type of pipe compatible with the apparatus (20) or method, in that the pipe has sufficient structural strength or integrity to withstand the slotting method or the operation or process performed by the apparatus (20).

The pipe (22) has a pipe wall (24) defining a bore (26) of the pipe (22), a pipe length and a longitudinal axis extending therethrough. Further, the pipe wall (24) has an external surface (28) defining a pipe circumference. One or more slots (30), and preferably a plurality of slots (30), are formed in the pipe wall (24).

In the preferred embodiment, as described below, the slots (30) are formed in a row extending along the pipe (22) and preferably aligned substantially parallel to the longitudinal axis of the pipe (22). Further, preferably a plurality of rows of slots (30) are formed in the pipe wall (24) about the pipe circumference. The method and the apparatus preferably provide for or permit the versatile, yet accurate, arrangement of the rows of slots (30) in varying configurations or patterns about the pipe circumference. For instance, the rows of slots (30) may be arranged such that adjacent slots (30) are side by side, in a staggered or offset arrangement or in a spiral or helical arrangement about the pipe circumference. In order to cut the rows of slots in a precise pattern or configuration, the slotting of the pipe (22) must be performed in a precise and controlled manner to ensure the proper and accurate placement of the slots (30) in the pipe wall (24).

As indicated, in order to provide for the various desired slotting configurations or patterns, the apparatus (20) and method of the within invention permit the cutting of the slots (30) at relatively precise circumferential and longitudinal positions in the pipe wall (24), as compared to conventional methods and apparatuses.

The number of slots (30) cut along the pipe length may be varied as required for any particular application. Generally, the number of slots (30) required, or desired, will be dependent upon, amongst other factors, the amount of pipe (22) that will be removed from the slots (30) in relationship to the total cross-sectional area of the pipe (22). Conventionally, the circumferential area of the pipe (22) removed by the slots (30) is about 3%. The percentage of cross-sectional area which may be removed will be dependent upon, amongst other factors, the desired strength of the pipe (22) and the desired open flow area provided by the slots (30).

Preferably, the apparatus (20) accommodates, and is operable on, varying lengths of pipe (22), varying diameters of pipe (22) and varying thicknesses of the pipe wall (24). With respect to the pipe length, the preferred embodiment of the apparatus (20) accommodates the total length of the pipe (22) such that a row of slots (30) may be formed concurrently or simultaneously along substantially the full or total pipe length or entire joint of the pipe (22). Typically an average joint length of casing is approximately 40 feet (12.192 m) long. Thus, in the preferred embodiment, the apparatus (20) is capable of handling pipe lengths of less than or equal to at least about 40 feet (12.192 m).

With respect to the pipe diameter, the apparatus (20) may be adapted to accommodate varying diameters of pipe (22) as discussed further below. However, the preferred embodiment of the apparatus (20) may be adapted to permit the accommodation of pipe diameters between about 4 inches (10.16 cm) and 9⅝ inches (24.45 cm). Finally, conventional casing typically has a wall thickness of about 0.5 inches (1.27 cm). Therefore, in the preferred embodiment, the apparatus (20) accommodates pipes (22) having a wall thickness of less than or equal to at least about 0.5 inches (1.27 cm). However, again, the apparatus (20) may be adapted to accommodate varying pipe wall (24) thicknesses.

Referring to FIGS. 1 and 2, the apparatus (20) has a front end (32) and a back end (34). The pipe (22) is preferably loaded and unloaded from the apparatus (20) at the front end (32). Further, the apparatus (20) is comprised of a stationary frame (36) for supporting and mounting the other elements of the apparatus (20) thereon. The stationary frame (36) provides structural support for the apparatus (20) and may be comprised of any suitable material for providing such a structural framework for the apparatus (20), such as lengths of steel tubing welded or bolted together into the desired configuration or structure to form the frame (36).

Referring to FIGS. 1 and 2, the apparatus (20) is further comprised of a stationary pipe bed (38), a clamping system (40) associated with the pipe bed (38) and a movable cutting head (42). The stationary pipe bed (38) is mounted with the stationary frame (36) in a fixed position or location on the stationary frame (36). The clamping system (42) is associated with the pipe bed (38) for releasably securing the pipe (22) to the pipe bed (38). The movable cutting head (40) is supported adjacent the pipe bed (38) by a movable frame (44), wherein the movable frame (44) is movably mounted with or movably supported on the stationary frame (36).

The pipe bed (38) is provided for supporting the pipe (22) thereon. Further, the pipe bed (38) has an upper surface (46) and a lower surface (48). Any surface or portion of the pipe bed (38) may be mounted with the stationary frame (36), However, preferably at least the lower surface (48) of the pipe bed (38) is mounted with the stationary frame (36) to maintain the position or location of the pipe bed (38) during slotting of the pipe (22) by the apparatus (20). Further, the clamping system (40) may be associated with the pipe bed (38) in any manner permitting the clamping system (40) to releasably secure the pipe (22) to the pipe bed (38) in a desired position. In the preferred embodiment, the clamping system (40) is associated with the upper surface (46) of the pipe bed (38) for ease of access to the pipe (22) by the cutting head (42).

As well, the pipe bed (38) has a pipe bed length. The pipe bed (38) may have any pipe bed length capable of supporting the pipe (22) thereon. However, preferably the pipe bed length is selected to be compatible with the pipe length such that the pipe (22) is supported by the pipe bed (38) substantially along the entire pipe length.

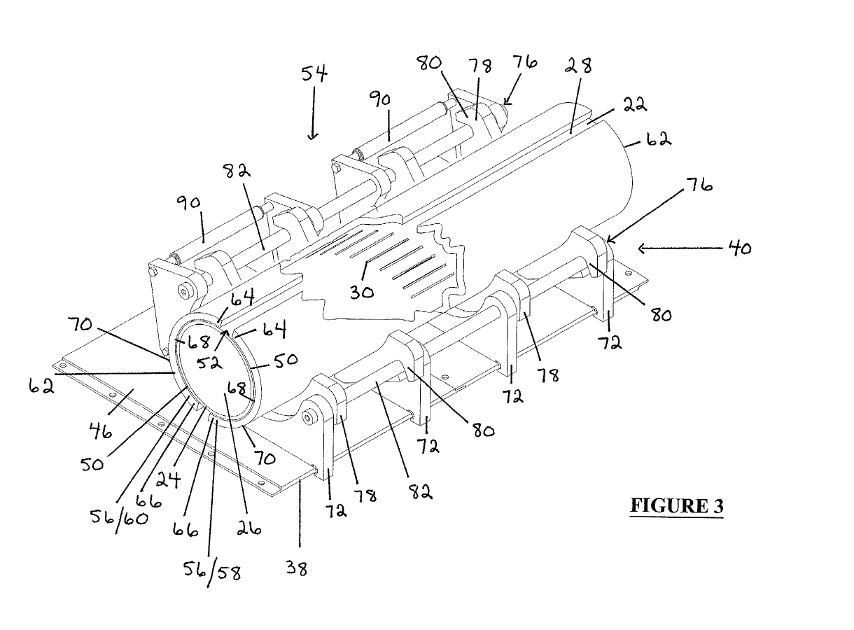

Referring to FIGS. 3-6, the clamping system (40) has a clamp length. The clamping system (40) may have any clamp length capable of releasably supporting the pipe (22) on the pipe bed (38). However, preferably the clamp length is selected to be compatible with the pipe bed length and thus the pipe length. Preferably, the clamp length extends along substantially the entire pipe bed length Accordingly, the pipe (22) is preferably releasably secured by the clamping system (40) substantially along the entire pipe length.

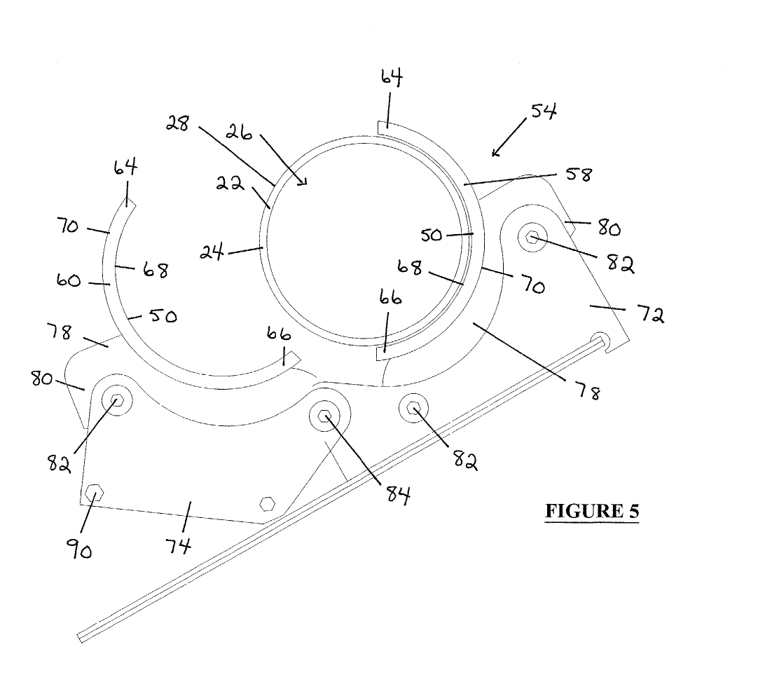

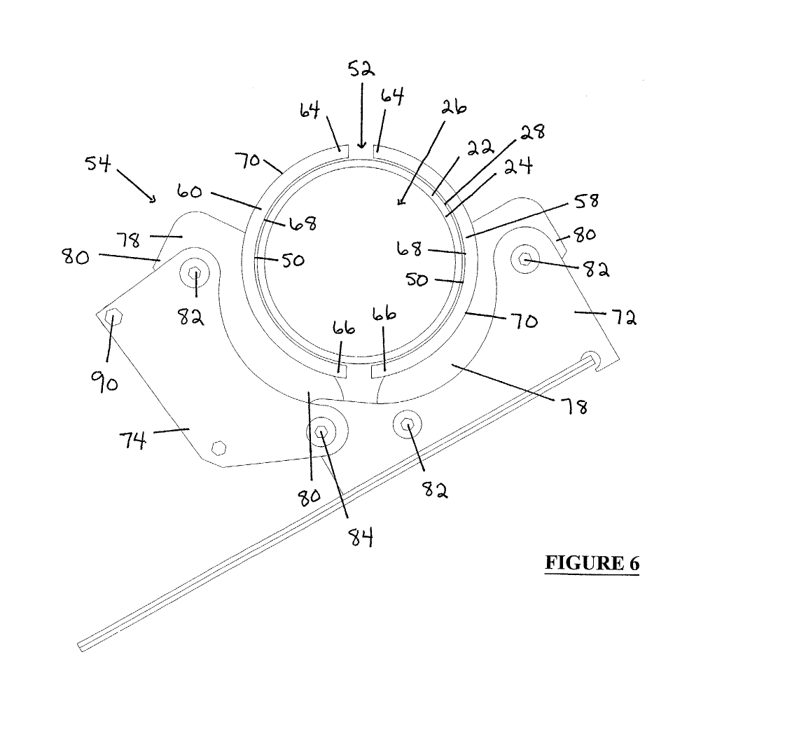

The clamping system (40) is movable between a clamped position for releasably securing the pipe (22) to the pipe bed (38), as shown in FIG. 5, and an unclamped position, as shown in FIG. 6. In the unclamped position, the clamping system (40) preferably opens sufficiently for easy access to the pipe (22) therein so that it may be readily removed from the clamping system (40).

Further, the clamping system (40) is comprised of a clamping surface (50) adapted to engage the pipe wall (24) in the clamped position. The surface area of the pipe wall (24) engaged by the clamping surface (50) may vary so long as the engagement between the pipe wall (24) and the clamping surface (50) is sufficient to firmly secure the pipe (22) in the desired position during slotting.

It has been found that in previous slotting apparatuses, in order to secure the pipe (22) in a desired position, that a relatively high clamping force on the pipe wall (24) may be required. Depending upon the size of the slots (30) and thickness of the pipe wall (24), the clamping force required to inhibit movement or vibration of the pipe (22) was found to be sufficient to crush the pipe (22) in some circumstances. As a result, the clamping surface (50) of the clamping system (40) of the within invention is adapted to engage the pipe wall (24) in a manner inhibiting any unwanted movement of the pipe (22) during slotting while applying a reduced clamping force to the pipe wall (24). Specifically, the clamping system (40) increases the surface area of the pipe wall (24) engaged by the clamping surface (50), which in turn, may reduce the clamping force required to retain the position of the pipe (22).

More particularly, the clamping surface (50) is adapted to engage in the clamped position at least about 50 percent of the pipe circumference and at least about 50 percent of the pipe length. Further, in order to permit the slotting of the pipe (22) in the clamped position, the clamping system (40) in the clamped position defines a longitudinal clamping gap (52) extending along the clamp length which is oriented to permit the slotting of the pipe (22) therethrough. The specific percent of the pipe circumference and the pipe length to be engaged by the clamping surface (50) may each be increased above 50 percent as required to securely engage the pipe (22) while applying a clamping force that will not significantly damage or adversely impact the structural integrity of the pipe (22). The particular percentages will thus vary depending upon, amongst other factors, the size and positioning of the slots (30) in the pipe (22) and the thickness of the pipe wall (24). Further, as indicated, each of the percentages must be selected while still providing for the longitudinal clamping gap (52).

For instance, preferably, the clamping surface (50) is adapted to engage at least about 70 percent of the pipe circumference in the clamped position, and more preferably at least about 90 percent of the pipe circumference in the clamped position. Further, preferably, the clamping surface (50) is adapted to engage at least about 70 percent of the pipe length in the clamped position, and more preferably at least about 90 percent of the pipe length in the clamped position. Any combination of percentages of engagement of the pipe length and the pipe circumference may be used. However, in the preferred embodiment, a combination of percentages is used wherein the clamping surface (50) is adapted to engage at least about 95 percent of the pipe circumference and at least about 90 percent of the pipe length in the clamped position.

The clamping surface (50) may be comprised of any structural component or member of the clamping system (40). However, preferably, the clamping system (40) is comprised of at least one clamp (54) which comprises the clamping surface (50). However, in order to support and secure the entire pipe length, in the preferred embodiment, the clamping system (40) is comprised of a plurality of clamps (54) which collectively comprise the clamping surface (50). The clamps (54) are longitudinally spaced along the pipe bed length for engaging the pipe circumference in the clamped position. The particular number of clamps (54) required will vary depending upon the pipe length. In the preferred embodiment, 20 clamps (54) are longitudinally positioned along the pipe bed (38) a spaced distance apart. More particularly, the clamps (54) are spaced longitudinally about 2 inches (5.08 cm) apart.

Each clamp (54) may be comprised of any suitable clamping device, structure, member or mechanism capable of providing the desired clamping surface (50) for engaging the pipe wall (24). Referring to FIGS. 3-6, in the preferred embodiment, each clamp (54) is comprised of a pair of clamp arms (56). In the unclamped position of the clamping system (40) as shown in FIG. 6, the clamp arms (56) are capable of being moved apart to permit ready access to the pipe (22). In the clamped position of the clamping assembly (40) as shown in FIG. 5, the clamp arms (56) define the longitudinal clamping gap (52) therebetween. The innermost or internal surface of the clamp arms (56) comprise the clamping surface (50) and are thus shaped or configured to be compatible with the pipe wall (24) to be clamped therein to provide the desired engagement between the pipe wall (24) and the clamping surface (50).

At least one of the clamp arms (56) is movable relative to the other clamp arm (56) to permit the movement of the clamping system (40) between the clamped and unclamped positions. Although both clamp arms (56) may be movable, in the preferred embodiment, the pair of clamp arms (56) includes a stationary clamp arm (58) and a movable clamp arm (60). Each of the stationary and movable clamp arms (58, 60) has opposed side ends (62) defining a length of the clamp arm therebetween, an upper end (64) and a lower end (66). Further, each of the stationary and movable clamp arms (58, 60) has an inner surface (68) which comprises the clamping surface (50) and an opposed outer surface (70).

In the clamped position, the longitudinal clamping gap (52) is defined between the adjacent upper ends (64) of the stationary and movable clamp arms (58, 60). The distance between the upper ends (64) defines the width of the longitudinal clamping gap (52), which will vary depending upon the percentage of the pipe circumference engaged by the clamping surface (50). However, at a minimum, the width of the longitudinal clamping gap (52) in the clamped position must be sufficient to permit the slotting of the pipe (22) therethrough.

Further, as indicated, the inner surface (68) of each clamp (58, 60) is sized to accommodate the pipe circumference. Accordingly, to accommodate varying sizes of pipe (22), and particularly pipe circumferences, the clamp arms (58, 60) are preferably removable and replaceable such that the clamp arms (58, 60) may be interchanged as necessary to be compatible with the pipe (22) to be clamped therebetween. As described in detail below, the clamping system (40) therefore provides a structure permitting the relatively easy and fast removal and replacement of the clamp arms (58, 60) so that the clamp arms (58, 60) may be readily changed as needed to be compatible with the pipe (22) to be slotted by the apparatus (20).

Each clamp (54) of the clamping system (40) may be comprised of any structure, members or assembly capable of maintaining the stationary clamp arm (58) in a fixed position while permitting the movement of the movable clamp arm (60) relative to the stationary clamp arm (58) between the clamped and unclamped positions of the clamping assembly (40). In the preferred embodiment, each clamp (54) is comprised of at least one stationary clamp bracket (72), and preferably a plurality of stationary clamp brackets (72), associated with the stationary clamp arm (58). Further, in the preferred embodiment, each clamp (54) is comprised of at least one movable clamp bracket (74), and preferably a plurality of movable clamp brackets (74), associated with the movable clamp arm (60). Referring to FIG. 1, either one of the stationary or the movable clamp brackets (72, 74) may be located nearer the cutting head (42) of the apparatus (20). However, preferably, the stationary clamp bracket (72) and the stationary clamp arm (58) associated therewith are positioned or located nearer the cutting head (42) in order to provide or permit freer movement of the movable clamp arm (60).

More particularly, referring to FIGS. 3, 5 and 6, a plurality of stationary clamp brackets (72) are fixedly or rigidly mounted, connected or otherwise attached with the upper surface (46) of the stationary pipe bed (38) adjacent the cutting head (42). Preferably, the stationary clamp brackets (72) are spaced apart longitudinally along the length of the stationary clamp arm (58) defined between the opposed side ends (62). In the preferred embodiment, four stationary clamp brackets (72) are rigidly secured to the upper surface (46) of the pipe bed (38) such that the stationary clamp brackets (72) are spaced apart between the opposed side ends (62) of the stationary clamp arm (58).

The stationary clamp arm (58) may be associated with the stationary clamp brackets (72) in any manner and by any mechanism wherein the stationary clamp brackets (72) maintain a fixed position of the stationary clamp arm (58). However, preferably, the stationary clamp arm (58) is associated with the stationary clamp brackets (72) in a manner and by a mechanism permitting the removal and replacement of the stationary clamp arm (58) from and to the stationary clamp brackets (72). In the preferred embodiment, the stationary clamp arm (58) is removably connected, mounted or attached with the stationary clamp brackets (72) by a releasable spring loaded pin system (76). The spring loaded pin system (76) is comprised of at least one clamp arm mounting member (78), and preferably a plurality of clamp arm mounting members (78), fixedly mounted with the outer surface (70) of the stationary clamp arm (58). In the preferred embodiment, four clamp arm mounting members (78) are fixedly mounted with the outer surface (70) such that the clamp arm mounting members (78) are spaced apart between the opposed side ends (62) of the stationary clamp arm (58). Each clamp arm mounting member (78) preferably includes opposed mounting ends (80).

The spring loaded pin system (76) is further comprised of at least one releasable spring loaded pin (80) extending between the stationary clamp arm brackets (72) for receipt within or extension through at least one of the mounting ends (80) of the clamp arm mounting member (78). In the preferred embodiment, two releasable spring loaded pins (80) extend between the stationary clamp arm brackets (72), wherein each of the mounting ends (80) of each clamp arm mounting member (78) are adapted for receiving or permitting the extension therethrough of one of the spring loaded pins (80).

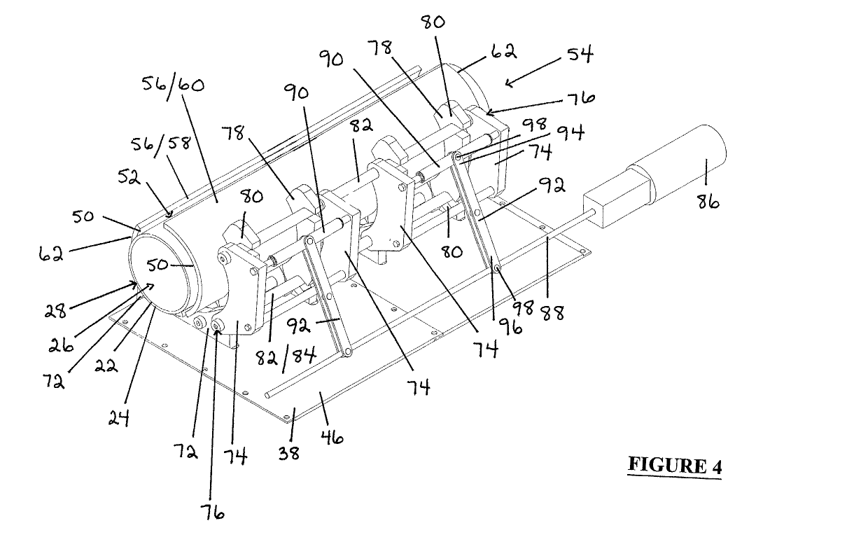

Referring to FIGS. 4-6, a plurality of movable clamp brackets (74) are movably mounted, connected or otherwise attached with the stationary clamp brackets (72). Preferably, one movable clamp bracket (74) is movably mounted with each stationary clamp bracket (72). Accordingly, the movable clamp brackets (74) are spaced apart longitudinally along the length of the movable clamp arm (60) defined between the opposed side ends (62). In the preferred embodiment, four movable clamp brackets (74) are movably mounted with the four stationary clamp brackets (72). The movable clamp brackets (74) may be movably mounted with the stationary clamp brackets (72) in any manner and by any mechanism, members or structure permitting the movable clamp brackets (74) and the movable clamp arm (60) associated therewith to move relative to the stationary clamp brackets (72) and the stationary clamp arm (58) associated therewith between the clamped and unclamped positions.

The movable clamp arm (60) may be associated with the movable clamp brackets (74) in any manner and by any mechanism wherein movement of the movable clamp brackets (74) results in a corresponding movement of the movable clamp arm (60). Further, preferably, the movable clamp arm (60) is associated with the movable clamp brackets (74) in a manner and by a mechanism permitting the removal and replacement of the movable clamp arm (60) from and to the movable clamp brackets (74).

In the preferred embodiment, the movable clamp arm (60) is removably connected, mounted or attached with the movable clamp brackets (74) by a further releasable spring loaded pin system (76) as described above for the stationary clamp arm (58). Again, the spring loaded pin system (76) is comprised of at least one clamp arm mounting member (78), and preferably a plurality of clamp arm mounting members (78), fixedly mounted with the outer surface (70) of the movable clamp arm (60). In the preferred embodiment, four clamp arm mounting members (78) are fixedly mounted with the outer surface (70) such that the clamp arm mounting members (78) are spaced apart between the opposed side ends (62) of the movable clamp arm (60). Each clamp arm mounting member (78) preferably includes opposed mounting ends (80).

Further, the spring loaded pin system (76) is again comprised of at least one releasable spring loaded pin (80) extending between the movable clamp arm brackets (74) for receipt within or extension through at least one of the mounting ends (80) of the clamp arm mounting member (78). In the preferred embodiment, two releasable spring loaded pins (80) extend between the movable clamp arm brackets (74), wherein each of the mounting ends (80) of each clamp arm mounting member (78) are adapted for receiving or permitting the extension therethrough of one of the spring loaded pins (80).

In the preferred embodiment, a lowermost releasable spring loaded pin (82) of the spring loaded system (76) associated with the movable clamp arm (60) extends through each of the stationary clamp brackets (72) as well as the movable clamp brackets (74) in order to movably mount the movable clamp brackets (74) with the stationary clamp brackets (72). Thus, the movable clamp brackets (74) and the movable clamp arm (60) associated therewith may pivot about the lowermost releasable spring loaded pin (82) to move relative to the stationary clamp brackets (72) and the stationary clamp arm (58) associated therewith between the clamped and unclamped positions of the clamping system (40).

The movable clamp brackets (74) may be caused to pivot about the lowermost releasable spring loaded pin (82) to move relative to the stationary clamp brackets (72) by any mechanism or structure capable of producing a controlled motion such that the clamping arms (58, 60) may engage the pipe wall (24) in the clamped position with a desired clamping pressure or force. Further, it is preferable that the mechanism or structure permit or provide for the locking or maintaining of the applied clamping pressure or force when the clamping system (40) is in the clamped position. This locked clamping pressure inhibits or precludes any movement of the clamping arms (58, 60) during the slotting of the pipe (22).

In the preferred embodiment, the clamping system (40) is further comprised of at least one hydraulic cylinder (86) operatively connected with the movable clamp arms (60) of the clamping system (40) such that actuation of the hydraulic cylinder (86) moves the clamping system (40) between the clamped and unclamped positions. The hydraulic cylinder (40) is preferably connected with the movable clamp arms (60) of each of the plurality of clamps (54) comprising the clamping system (40) so that each of the movable clamp arms (60) is concurrently actuated by the hydraulic cylinder (86) for a controlled and consistent motion and application of the clamping pressure to the pipe wall (24).

The hydraulic cylinder (86) may be operatively connected with the movable clamp arms (60) by any system of linkages therebetween. In the preferred embodiment, the clamping system (40) is comprised of a clamp rod (88) extending longitudinally for substantially the entire clamp length. The clamp rod (88) is actuated by the hydraulic cylinder (86) such that the clamp rod (88) is reciprocated longitudinally. Further, the clamping system (40) is comprised of at least one bracket rod (90) associated with each clamp (54), wherein the bracket rod (90) is mounted or connected between at least two adjacent movable clamp brackets (74). In the preferred embodiment, each clamp (54) includes two bracket rods (90) mounted or connected between adjacent movable clamp brackets (74).

Finally, the clamping system (40) is comprised of at least one linkage member (92) for pivotally linking the clamp rod (88) with the at least one bracket rod (90). Thus, in the preferred embodiment, a plurality of linkage members (92) are provided for linking each of the plurality of bracket rods (90) with the clamp rod (88). More particularly, a first end (94) of the linkage member (92) is pivotally connected with the bracket rod (90), while a second end (96) of the linkage member (92) is pivotally connected with the clamp rod (88). Each of the first and second ends (94, 96) may be pivotally connected by a pin (98), bolt, screw or other suitable fastener with the bracket rod (90) and clamp rod (88) respectively. As a result, actuation of the hydraulic cylinder (86) longitudinally reciprocates the clamp rod (88) which is translated by the linkage members (92) into a pivoting movement to cause the movable clamp brackets (74) to pivot about the stationary clamp brackets (72) between the unclamped and clamped positions.

In the clamped position, the amount or level of the fluid within the hydraulic cylinder (86) may be inhibited from leakage or otherwise maintained at a desired level within the hydraulic cylinder (86) in order to lock or maintain the clamping pressure or force being applied by the clamping system (40). Preferably, following charging of the hydraulic cylinder (86) with fluid, the cylinder valves (not shown) are closed to prevent any loss of fluid from the hydraulic cylinder (86). As the fluid within the hydraulic cylinder (86) is substantially incompressible, movement of the movable clamping arm (60) towards the unclamped position is inhibited or precluded during the slotting of the pipe (22).

As indicated, the apparatus (20) is further comprised of the cutting head (42). The cutting head (42) includes at least one cutter (100) for slotting the pipe (22). In the preferred embodiment, the cutting head (42) is comprised of a plurality of cutters (100). Therefore a plurality of slots (30) are formed in the pipe (22) by the apparatus (20). The cutters (100) are comprised of circular blades or saws in the preferred embodiment. However, the cutters (100) may also use drill bits, laser cutting, gas cutting, water cutting, electronic discharge cutting or any other device, apparatus, mechanism or method suitable for, and compatible with, cutting the pipe (22) in the manner described herein.

The cutters (100) are preferably linearly arranged along the cutting head (42) in a row such that the row is substantially parallel to the longitudinal clamping gap (52). Thus, the cutters (100) are preferably linearly arranged along the cutting head (42) in a row substantially parallel to the longitudinal axis of the pipe (22) in the clamped position on the pipe bed (38). However, the cutters (100) may be arranged in any pattern or configuration suitable for, and compatible with, the particular pipe (22) being slotted and the intended use or application of the pipe (22).

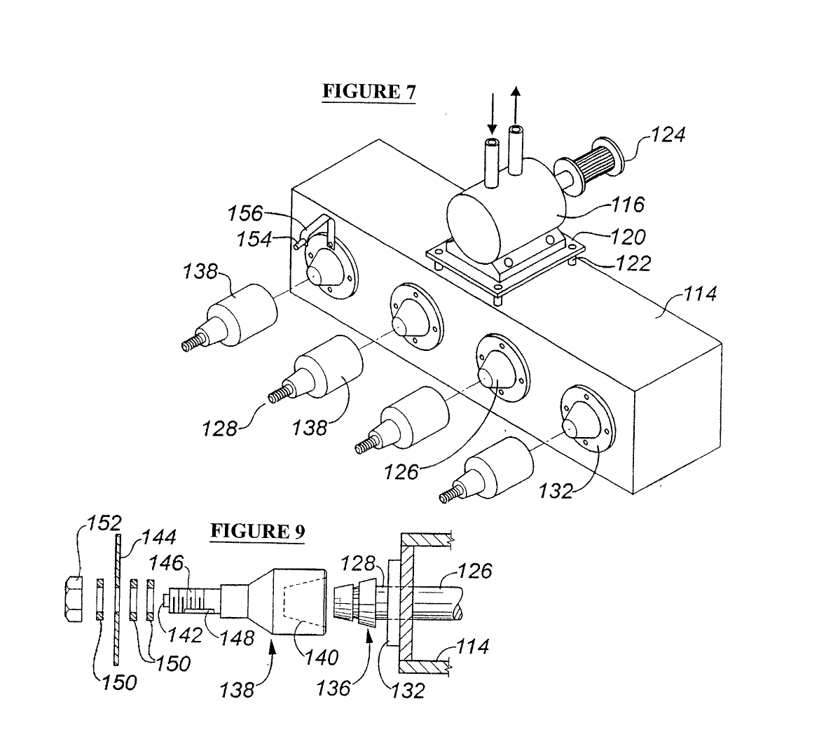

More particularly, in the preferred embodiment, the cutting head (42) is comprised of one or more, and preferably a plurality of, cutting boxes (114). The cutting boxes (114) are mounted adjacent to each other along the length of the cutting head (42) as shown in FIG. 2. In the preferred embodiment, the cutting head (42) includes twenty cutting boxes (114), wherein each clamp (54) is matched with a corresponding cutting box (114). Referring to FIG. 2, the discontinuous vertical line shows a break in the length of the apparatus (20), however, the structure provided on either side of the discontinuous line is repeated for the length of the apparatus (20). Thus, although five cutting boxes (114) are shown therein, as stated above, the cutting head (42) includes twenty cutting boxes (114) in the preferred embodiment. Further, referring to FIGS. 7-10, each cutting box (114) is comprised of, and contains, one or more cutters (100). In the preferred embodiment, each cutting box (114) includes four cutters (100). Thus, in the preferred embodiment, the cutting head (42) permits a total of eighty slots to be cut along the length of the pipe (22) by the cutting head (42).

Further, each cutting box (114) is associated with a power source for operation of the cutters (100). In the preferred embodiment, the power source is comprised of a motor, preferably a hydraulic motor (116), mounted to the cutting box (114) and operatively connected to each cutter (100). Specifically, the motor (116) operates the cutters (100) by a two belt (118) pulley system, wherein the belts (118) are arranged between the motor (116) and the cutters (100), as shown in FIG. 10. In the preferred embodiment, the cutters (100) may be rotated in one or both directions by the motors (116). Specifically, during slotting of the pipe (22) by the cutters (100), a number of the cutters (100) will typically be rotated in one direction, while a number of the cutters (100) are concurrently rotated in the opposite direction. In this manner, any unwanted horizontal movement of the cutters (100) is further inhibited or minimized.

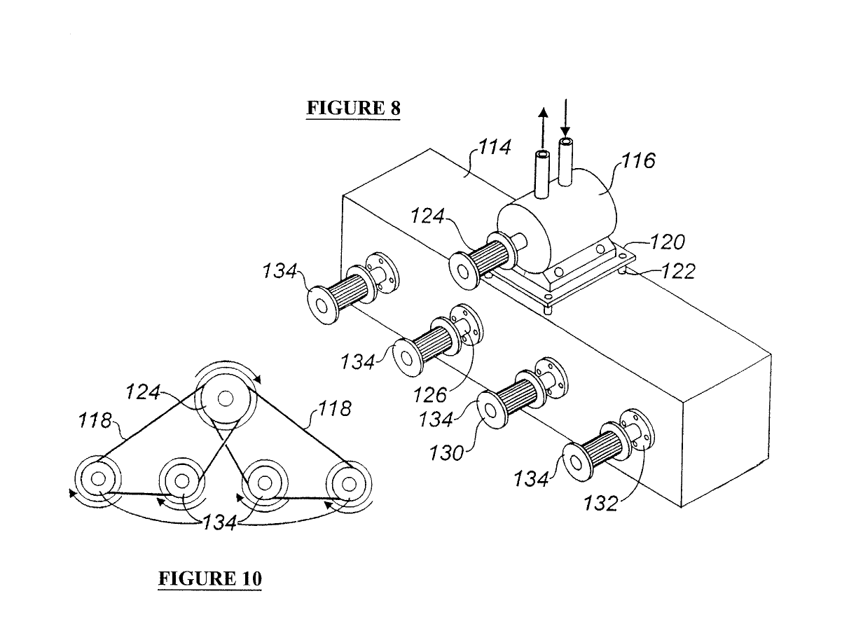

As shown in FIGS. 7 and 8, the motor (116) is fixedly mounted to a mounting plate (120) by bolts or other suitable fasteners. The plate (120) is then adjustably mounted to the cutting box (114) by four adjustable screws (122). The adjustment of the adjustable screws (122) permits the loosening and tightening of the belts (118), as well as the proper alignment of the belts (118). Activation of the motor (116) causes rotation of a motor pulley (124).

Each cutter (100) includes a spindle (126), having a front end (128) and a back end (130). The front and back ends (128, 130) of each spindle (126) extend through the cutting box (114) and are supported in the cutting box (114) by bearing and seal assemblies (132). Each spindle (126) is held in position in the cutting box (114) by adjusting both bearing and seal assemblies (132). Further, the back end (130) of each spindle (126) includes a spindle pulley (134). Referring to FIG. 10, each of the two belts (118) is mounted about the motor pulley (124) and two spindle pulleys (134). Thus, two belts (118) are able to operate all four spindle pulleys (134).

Further, a cog wheel (not shown) may be mounted to the back end (130) of the spindle pulley (134) of one spindle (126) in the cutting box (114). Thus, only one cog wheel is located on each cutting box (114). The cog wheel (not shown) is contained within a sensor or counter (not shown) which is attached to the bearing and seal assembly (132) on the spindle (126). The sensor or counter (not shown) is designed to count the teeth of the cog wheel as the cog wheel is rotated by the spindle (126). The data from the counting of the teeth may be sent to a computer system, as described further below, in order to calculate and determine the rotations per minute (rpm) of the spindle (126). In operation, each of the four spindles (126) in a cutting box (114) will rotate at the same rpm. However, the rpm may tend to vary between cutting boxes (114). The information sent to the computer system by the cog wheel may therefore be used to adjust the flow of the hydraulic fluid to the hydraulic motors (116) of the various cutting boxes (114) in order to synchronize the rpm of all cutting boxes (114), to ensure that all cutter blades (144) are running at approximately the same rpm.

Referring to FIG. 9, the front end (128) of each spindle (126) includes a tapered portion (136). An arbor (138), spindle connector or other suitable connector, having a tapered portion (140) complimentary to the tapered portion (136) of the spindle (126), is mounted to the front end (128) of the spindle (126). Thus, the diameter of the tapered portion (140) of the arbor (138) is sized to fit onto the outside diameter of the tapered portion (136) of the front end (128) of the spindle (126). A nut (142) or other suitable fastening means is used to connect the arbor (138) to the spindle (126). Specifically, the nut (142) extends through the arbor (138) and screws onto the front end (128) of the spindle (126). Thus, the arbor (138) is held in position.

As indicated, the arbor (138) includes a tapered portion (140) at one end thereof. The opposite end of the arbor (138) is operatively connected to a cutter blade (144). In the preferred embodiment, the end of the arbor (138) to be connected to the blade (144) includes a threaded portion (146) and an adjacent keyway cut (148). The blade (144) defines an opening for the mounting of the blade (144) on the arbor (138). Specifically, the end of the arbor (138) is inserted through the opening in the blade (144) until such time that the blade (144) is located within the keyway cut (148). One or more spacers (150) are also located within the keyway cut (148) in order to secure the blade (144) therein and inhibit rotation of the blade (144) on the spindle (126). The spacers (150) and the blade (144) are tightened and held into position by an arbor nut (152) which is threaded onto the threaded portion (146) of the arbor (138). Different sizes of spacers (150) are used to ensure that the centre of any particular blade (144) is aligned with the top dead centre line of the pipe, in the preferred embodiment.

As indicated, in the preferred embodiment, a single blade (144) is mounted upon each spindle (126) in the manner described above. However, more than one blade (144) may be mounted to each spindle (126) where desirable for a particular application. For instance, two or more blades (144) may be mounted on the spindle (126) a spaced distance apart in order that greater than one row of slots (30) may be cut concurrently or simultaneously.

The cutting box (114) may also include a sensor or proximity switch (154), as shown in FIG. 7, which is mounted to a bracket (156), which is in turn mounted to the bearing and seal assembly (132) at the front end (128) of one of the spindles (126). The proximity switch or sensor (154) relays a message to the computer system confirming the presence of a blade (144) at the front end (128) of the spindle (126). In other words, the proximity switch or sensor (154) works in relationship to the blade (144) itself. Thus, if a blade (144) breaks, the proximity switch or sensor (154) can relay a message to the computer identifying the breakdown of the blade (144). Thus, the proximity switch or sensor (154) provides a safety feature to the apparatus (20).

The slots (30) cut in the pipe wall (24) may have any desired slot width and any desired slot length. For instance, typically, conventional apparatuses are capable of cutting slots having a slot length of between 1.5 inches (3.81 cm) and 2.5 inches (6.35 cm). The apparatus (20) permits the cutting of slots (30) having such typical slot lengths, however, the apparatus (20) further permits the cutting of slots (30) having a slot length of greater than 2.5 inches (6.35 cm) to a maximum of about 12 inches (30.48 cm). Thus, in the preferred embodiment, the apparatus (20) permits the cutting of slots (30) having a slot length of between about 1.5 inches (3.81 cm) and 12 inches (30.48 cm). Further, in the preferred embodiment, the slot width is between about 0.008 inches (0.02032 cm) and 0.250 inches (0.635 cm). However, the specific configuration of the cutting head (42), the particular blade (144) being used and the distance between the centre line of each blade (144) or spindle (126) may be varied as required for the particular application or pipe (22) to be slotted. For instance, additional blades (144) may be added or every second blade (144) may be removed to permit shorter or longer slots (30) to be cut in the pipe (22). In the preferred embodiment, the cutting head (42) is able to move longitudinally, as described below, for a distance of about twelve inches (30.48 cm).

In addition, the apparatus (20) includes a precise motion control system which includes three independent systems or mechanisms: a first perforating mechanism; a second longitudinal moving mechanism; and a third indexing mechanism. Each of the first, second and third mechanisms (158, 160, 162) is preferably operable independently from the others and performs its function in sequence with the others. The relatively precise control provided by these independent mechanisms permits variable slotting patterns to be cut in the pipe (22) having both precise and consistent slot (30) dimensions or geometries.

The first perforating mechanism (158), preferably operable independently from the second and third mechanisms (160, 162), provides for precise control over the elevation of the cutting head (42). More particularly, the first perforating mechanism (158) moves the cutting head (42) toward and away from the longitudinal clamping gap (52) such that the pipe wall (24) is perforated by the cutters (100) through the longitudinal clamping gap (52) at a location of contact between the cutters (100) and the pipe wall (22).

The second longitudinal cutting mechanism (160), preferably operable independently from the first and third mechanisms (158, 162), provides for precise control over the translation of the cutting head (42) and thus the slot length. More particularly, the second longitudinal cutting mechanism (160) moves the cutting head (42) longitudinally relative to the pipe bed (38) along the longitudinal clamping gap (52) such that the perforated pipe wall (24) is further cut by the cutters (100) through the longitudinal clamping gap (52) to form a plurality of discrete slots (30), each of the slots (30) having a slot length.

The third indexing mechanism (162), preferably operable independently from the first and second mechanisms (158, 160), provides for precise control over the rotation of the pipe (22). More particularly, the third indexing mechanism (162) rotates the pipe (22) about the pipe longitudinal axis when the clamping system (40) is in the unclamped position such that the location of contact between the cutters (100) and the pipe wall (24) is varied about the pipe circumference.

The first perforating mechanism (158) may be comprised of any suitable apparatus, mechanism, device or structure capable of performing the required function described above, and specifically, capable of moving the cutting head (42) toward and away from the longitudinal clamping gap (52) in the manner and for the purposes described herein.

The first perforating mechanism (158) preferably moves the cutting head (42) so that the longitudinal axis of the cutting head (42) is substantially parallel to the longitudinal axis of the pipe (22) in the clamped position. Accordingly, the cutters (100) preferably concurrently or simultaneously form each of the slots (30) in the row in the pipe wall (24). As well, the row of slots (30) is thus formed substantially parallel to the longitudinal axis of the pipe (22). However, where suitable for, and compatible with, the particular pipe (22) being slotted and the intended use or application of the pipe (22), the longitudinal axis of the cutting head (42) may be other than parallel to the longitudinal axis of the pipe (22), provided the cutters (100) are able to perforate the pipe wall (24) through the longitudinal clamping gap (52), so that the row of slots (30) may be formed along the pipe (22) other than parallel to its longitudinal axis.

In the preferred embodiment, the cutters (100) also preferably contact the uppermost part of the pipe (22), or the top dead centre line of the pipe (22), such that the row of slots (30) is formed thereon. However, the specific configuration and structural relationship of the cutting head (42) and the pipe bed (38) may be varied as desired for any particular application such that the cutters (100) may contact the pipe wall (24) and form the slots (30) at any other location about the pipe circumference.

In the preferred embodiment, the first perforating mechanism (158) is comprised of the movable frame (44) for supporting the cutting head (42) adjacent to the pipe bed (38), a carriage (164) for supporting the movable frame (44) and a gear assembly (166) operatively associated with the carriage (164). More particularly, referring to FIGS. 1 and 2, the movable frame (44) supports the cutting head (42) adjacent the pipe bed (38) such that the row of cutters (100) is movable towards and away from the longitudinal clamping gap (52). In other words, movement of the movable frame (44) moves the row of cutters (100) either towards or away from the longitudinal clamping gap (52) in order to move the cutters (100) into and out of contact with the pipe wall (24). In the preferred embodiment, the location of contact between the cutters (100) and the pipe wall (24) is at the top dead centre line of the pipe (22). Further, the movable frame (44) preferably supports the cutting head (42) such that the row of cutters (100) is movable substantially vertically towards and away from the longitudinal clamping gap (52), which is positioned at the top dead centre of the pipe (22), in order to perforate the pipe wall (24) with the cutters (100).

Thus, the movable frame (44) is movable in a manner and a direction such that the row of cutters (100) is preferably moved substantially vertically. In the preferred embodiment, the movable frame (44) is movable in a substantially vertical plane such that vertical movement of the movable frame (44) results in a corresponding vertical movement of the cutting head (42) supported thereon. The cutting head (42) may be supported by the movable frame (44) in any manner and by any mechanism or structure permitting the corresponding movement of the movable frame (44) and the cutting head (42).

The movable frame (44) may be comprised of a single member or element or a plurality of members or elements connected or mounted together to provide the complete movable frame (44). In the preferred embodiment, the movable frame (44) is comprised of at least one upper member (168) having an upper surface (168) for supporting the cutting head (42) thereon. Further, the movable frame (44) is comprised of at least one and preferably a plurality of lower members (172), each having a lower surface (174) associated with the carriage (164). The upper member (168) is preferably fixedly supported upon or mounted with the lower member (172) such that movement therebetween is inhibited or precluded. In addition, the movable frame (44) preferably extends longitudinally adjacent the pipe bed (38) for substantially the entire pipe bed length in order to filly support the length of the cutting head (42) thereon.

The carriage (164) is provided for supporting the movable frame (44) thereon. Although any portion of the movable frame (44) may be supported by the carriage (164), the carriage (164) is preferably associated with each of the lower members (172) of the movable frame (44) and more particularly, the lower surfaces (174). Further, the carriage (164) supports the movable frame (44) such that the carriage (164) is movable longitudinally relative to the pipe bed (38). More particularly, the carriage (164) may be associated with the movable frame (44) in any manner and by any mechanism or structure such that the longitudinal movement of the carriage (164) relative to the pipe bed (38) causes or results in the movement of the cutters (100) either towards or away from the longitudinal clamping gap (52) as described above. In the preferred embodiment, the longitudinal movement of the carriage (164) is translated into the movement of the cutting head (42) and the cutters (100).

In the preferred embodiment, the carriage (164) is movable longitudinally adjacent the pipe bed (38) in a substantially horizontal plane. This longitudinal horizontal movement of the carriage (164) is translated into the movement of the movable frame (44) in a substantially vertical plane, wherein the vertical movement of the movable frame (44) results in a corresponding vertical movement of the cutting head (42) supported thereon.

Any structure or mechanism may be provided permitting the longitudinal movement or sliding of the carriage (164) adjacent the pipe bed (38). Referring to FIGS. 1 and 2, in the preferred embodiment, the carriage (164) is slidably or movably mounted upon or with the stationary frame (36) of the apparatus (20). More particularly, a plurality of bearings (175) are positioned between the carriage (164) and the stationary frame (36) to facilitate the reciprocating longitudinal movement of the carriage (164) relative to the stationary frame (36).

The bearings (175) may be comprised of any type of bearings or bearing structure compatible with and suitable for the intended function. For instance, one or more elongate rails (not shown) may be fastened along the stationary frame (36) adjacent the pipe bed (38) for substantially the entire pipe bed length. Similarly, a plurality of bearing boxes (not shown) may be fastened along the lowermost surface of the carriage (164) adjacent the stationary frame (36). The plurality of bearing boxes are then slidably mounted on each rail such that the bearing boxes are permitted to slide horizontally thereon along the length of the rails.

Further, any structure or mechanism may be provided for translating the horizontal movement of the carriage (164) into the vertical movement of the movable frame (44). In the preferred embodiment, the first perforating mechanism (158) is further comprised of at least one and preferably a plurality of wedge-shaped brackets (176). Preferably, one wedge-shaped bracket (176) is positioned between the carriage (164) and the lower surface (174) of each lower member (172) of the movable frame (44).

More particularly, each wedge-shaped bracket (176) has a lower surface (178) and an upper surface (180). The lower surface (178) is fixedly mounted, attached or connected with the carriage (164) such that the longitudinal reciprocating movement of the carriage (164) relative to the pipe bed (38) causes a corresponding longitudinal reciprocating movement of the wedge-shaped bracket (176). The upper surface (180) of each wedge-shaped bracket (176) is sloped to form the wedge-shape of the bracket (176). The lower surface (174) of each lower member (172) of the movable frame (44) is similarly provided with a slope compatible with and corresponding to the slope of the upper surface (180) of the wedge-shaped bracket (176), as shown in FIG. 2. Accordingly, in the preferred embodiment, the longitudinal horizontal movement of the carriage (164) is translated into the vertical movement of the movable frame (44) by the engagement of the correspondingly sloped upper and lower surfaces (180, 174) of the wedge-shaped bracket (176) and lower member (172) respectively.

Preferably, a plurality of bearings (175) are positioned between the sloped upper and lower surfaces (180, 174) of the wedge-shaped bracket (176) and lower member (172) respectively to facilitate the sliding movement therebetween. Again, the bearings (175) may be comprised of any type of bearings or bearing structure compatible with and suitable for the intended function. For instance, one or more elongate rails (not shown) may be fastened along the sloped upper surface (180) of the wedge-shaped bracket (176). A plurality of bearing boxes (not shown) may be fastened along the sloped lower surface (174) of the lower member (172). The plurality of bearing boxes are then slidably mounted on each rail such that the bearing boxes are permitted to slide thereon along the length of the rails.

Further, a plurality of bearings (175) may be associated with each of the lower members (172) of the movable frame (44) along at least one side surface (182) for directing and facilitating the movement of the lower member (172) in a substantially vertical plane. More particularly, a plurality of vertical linear bearings (175) are preferably associated with at least one side surface (182) of each lower member (172) to direct and cause the movable frame (44), and thus the cutting head (42), to move in a substantially vertical direction. The bearings (175) may be comprised of any type of bearings or bearing structure compatible with and suitable for the intended function.

Finally, the first perforating mechanism (158) is comprised of a mechanism or device for moving the carriage (164) longitudinally. Although the carriage (164) may be moved longitudinally by any mechanism, structure or device capable of causing the desired longitudinal movement, preferably, the first perforating mechanism (158) is comprised of the gear assembly (166). Any gear assembly (166) operatively connected with the carriage (164) to longitudinally move the carriage (164) may be used. However, in the preferred embodiment, the gear assembly (166) is comprised of a rack and worm gear system.

More particularly, the gear assembly (166) is comprised of a rack (184) operatively connected with the carriage (164) such that movement of the rack (184) longitudinally moves the carriage (164). In the preferred embodiment, the rack (184) is connected or mounted with an end of the carriage (164), preferably adjacent the back end (34) of the apparatus (20). Further, the gear assembly (166) is comprised of a worm (186). The worm (186) drivingly engages the rack (184) such that rotation of the worm (186) moves the rack (184) and thus the carriage (164) longitudinally. Rotation of the worm (186) in a first direction reciprocates the carriage (164) in a first direction causing the cutting head (42) to move vertically upwards such that the cutters (100) are moved away from the longitudinal clamping gap (52). Rotation of the worm (186) in an opposed second direction reciprocates the carriage (164) in an opposed second direction causing the cutting head (42) to move vertically downwards such that the cutters (100) are moved towards the longitudinal clamping gap (52).

The worm (186) is actuated by a gear box (188) and a motor (190). Although any suitable motor (190) may be used, the motor (190) is preferably a variable speed electric motor. In the preferred embodiment, the gear box (188) and the motor (190) are mounted or connected with the stationary frame (36), preferably adjacent the back end (34) of the apparatus (20). The preferred embodiment of the gear assembly (166) permits or provides for a controlled, gradual and relatively precise movement of the first perforating mechanism (158). More particularly, precise controlled movement of the carriage (164) horizontally by the rack (184) and worm (186) results in a precise controlled vertical movement of the cutting head (42). As a result, the speed and precision with which the cutters (100) perforate the pipe wall (24) may also be closely controlled during the slotting of the pipe (22).

The second longitudinal cutting mechanism (160) may be comprised of any suitable apparatus, mechanism, device or structure capable of performing the required function described above, and specifically, capable of moving the cutting head (42) longitudinally relative to the pipe bed (38) along the longitudinal clamping gap (52) in the manner and for the purposes described herein. However, in the preferred embodiment of the apparatus (20), the second longitudinal cutting mechanism (160) will cause a substantially horizontal movement of the cutting head (42).

More particularly, the second longitudinal cutting mechanism (160) moves the cutting head (42) longitudinally relative to the pipe bed (38) along the longitudinal clamping gap (52) for a distance such that the perforated pipe wall (24) is further cut by the cutters (100) through the longitudinal clamping gap (52) to form a plurality of discrete slots (30), each of the slots (30) having a slot length. The movement of the cutting head (42) for a distance selected by the operator of the apparatus (20) results in the formation of slots (30) having a desired slot length. In this case, the length of the slots (30) will not be solely determined or controlled by the size, shape or type of cutters (100) used in the cutting head (42). More specifically, where the cutters (100) include a blade or circular saw, the length of the slot (30) will not be solely determined or controlled by the diameter of the blade.

The second longitudinal cutting mechanism (160) is operatively connected with the cutting head (42) to move the cutting head (42) relative to the stationary pipe bed (38) along the longitudinal clamping gap (52). Thus, in the preferred embodiment, following the perforation of the pipe wall (24) by the cutters (100) as a result of the substantially vertical movement of the cutting head (42) by operation of the first perforating mechanism (158), the second longitudinal cutting mechanism (160) causes the cutting head (42) to move substantially horizontally such that the cutters (100) cut the pipe wall (24) to form the slots (30) therein. When the cutters (100) are not in contact with the pipe wall (24), the second longitudinal cutting mechanism (160) permits the contact location between the pipe (22) and the cutters (100) to be varied longitudinally along the pipe (22).

The ability of the apparatus (20) to move the cutting head (42) longitudinally by the second longitudinal cutting mechanism (160) may give rise to several advantages of the apparatus (20), as compared to conventional casing slotters. For instance, the length of the slots (30) may no longer be primarily or solely determined or controlled by the type and size of cutters (100) used in the apparatus (20), and in particular, by the diameter of the circular cutting blade. Accordingly, a smaller diameter blade, having greater stability as compared to larger blades, may be used. As a result, blade breakage may be reduced and cutting speeds may be increased. As well, the apparatus (20) may allow for greater control of slot width deviation and may allow for relatively narrower or finer slot widths to be cut in conventional casing, as compared to conventional casing slotters, thus obviating the need for wire wrapped casing.

By increasing the length of the slot (30) and keeping the open flow area of the slot (30) constant, the cross sectional area removed by the slotting process will be decreased. This may increase both the tensile and torsional strength of the pipe (22). If the strength of the pipe (22) is kept consistent with a comparable slotted liner produced by conventional casing slotters, the cross sectional area removed by the slotting process would remain the same but the open flow area of the slot (30) may be increased. This increased open flow area may result in an increased production through the pipe (22). If the open flow area is kept consistent with a comparable slotted liner produced by conventional casing slotters, the cost of producing the slotted pipe (22) may be reduced by increasing the slot length and decreasing the amount of rows cut.

In the preferred embodiment, the cutting head (42) is mounted or supported upon the movable frame (44) in a manner and by any mechanism or structure permitting the longitudinal movement of the cutting head (42) as described above. As previously discussed, in the preferred embodiment, the cutting head (42) is preferably supported upon the upper surface (170) of the upper member (168) of the movable frame (44) such that vertical movement of the movable frame (44) vertically moves the cutting head (42). In addition, in the preferred embodiment, the cutting head (42) is supported on the upper surface (170) by a mechanism permitting the substantially horizontal reciprocating movement of the cutting head (42) longitudinally thereon.

The cutting head (42) may be slidably or movably mounted with the movable frame (44) in any manner and by any mechanism or structure permitting the necessary movement of the cutting head (42) as described above. In the preferred embodiment, the lowermost surfaces of each of the cutting boxes (114) comprise a lower surface (192) of the cutting head (42). The lower surface (192) of the cutting head (42) is slidable or movable along the upper surface (170) of the upper member (168) of the movable frame (44). Preferably, a plurality of bearings (175) are positioned between the adjacent lower and upper surfaces (192, 170) of the cutting head (42) and the upper member (168) respectively to facilitate the sliding movement therebetween.

The bearings (175) may be comprised of any type of bearings or bearing structure compatible with and suitable for the intended function. For instance, one or more elongate rails (not shown) may be fastened along the upper surface (170) of the upper member (168) of the movable frame (44). A plurality of bearing boxes (not shown) may be fastened along the lower surface (192) of the cutting head (42). The plurality of bearing boxes are then slidably mounted on each rail such that the bearing boxes are permitted to slide thereon along the length of the rails.

The second longitudinal cutting mechanism (160) may be comprised of any mechanism or device capable of longitudinally moving the cutting head (42) along the bearings (175) in the previously described direction. However, preferably, the second longitudinal cutting mechanism (160) is also comprised of a gear assembly (194) similar to the gear assembly (166) previously described for the first perforating mechanism (158). Any gear assembly (194) operatively connected with the cutting head (42) to longitudinally move the cutting head (42) may be used. However, in the preferred embodiment, the gear assembly (194) is comprised of a rack and worm gear assembly.

More particularly, the gear assembly (194) is comprised of a rack (196) operatively connected with the cutting head (42) such that movement of the rack (196) longitudinally moves the cutting head (42). In the preferred embodiment, the rack (196) is connected or mounted with an end of the cutting head (42), preferably adjacent the back end (34) of the apparatus (20). Further, the gear assembly (194) is comprised of a worm (198). The worm (198) drivingly engages the rack (196) such that rotation of the worm (198) moves the rack (196) and thus the cutting head (42) longitudinally. Rotation of the worm (198) in a first direction reciprocates the cutting head (42) relative to the pipe bed (38) horizontally in a first direction along the longitudinal clamping gap (52). Rotation of the worm (198) in an opposed second direction reciprocates the cutting head (42) relative to the pipe bed (38) horizontally in an opposed second direction along the longitudinal clamping gap (52).

The worm (198) is actuated by a gear box (200) and a motor (202). Although any suitable motor (202) may be used, the motor (202) is preferably a variable speed electric motor. In the preferred embodiment, the gear box (200) and the motor (202) are mounted or connected with the upper member (168) of the movable frame (44), preferably adjacent the back end (34) of the apparatus (20). The preferred embodiment of the gear assembly (194) permits or provides for a controlled, gradual and relatively precise movement of the cutting head (42) by the second longitudinal cutting mechanism (160). More particularly, precise controlled movement of the cutting head (42) horizontally by the rack (196) and worm (198) results in a precise controlled horizontal movement of the cutters (100) to from the slots (30) with precision in the pipe wall (24) to ensure accurate slot (30) geometry and configuration.

Further, the apparatus (20) is also preferably comprised of the third indexing mechanism (162) for rotating the pipe (22) about its longitudinal axis when the clamping system (40) is in the unclamped position. As a result, the location of contact between the cutters (100) and the pipe wall (24) may be varied about the pipe circumference. The third indexing mechanism (162) permits the location of contact between the cutters (100) and the pipe wall (24) to be varied 360 degrees about the pipe circumference. Therefore, any number of rows of slots (30), as desired, may be cut. The combination of the first perforating mechanism (158), the second longitudinal cutting mechanism (160) and the third indexing mechanism (162) allows the apparatus (20) to cut a broad range of slot patterns in the pipe (22) to suit the particular needs of the pipe (22) for a specific use or application.

Although the third indexing mechanism (162) may be positioned at any location along the pipe length, referring to FIG. 2, the third indexing mechanism (162) is preferably associated with the stationary frame (36) adjacent an end of the apparatus (20), preferably the front end (21). Accordingly, when the pipe (22) is supported by the pipe bed (38) in the unclamped position, an end of the pipe (22) may be secured by the third indexing mechanism (162).

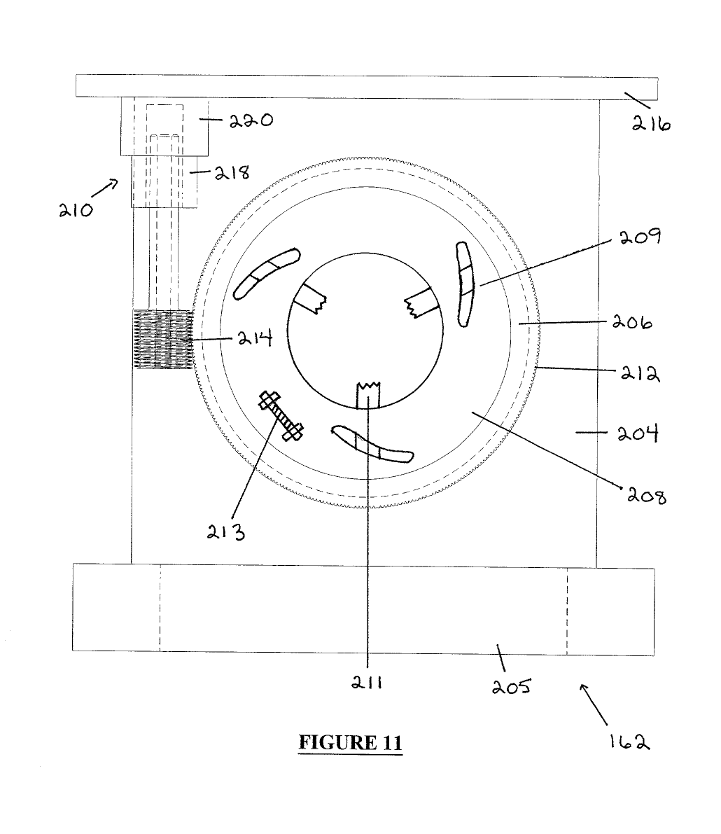

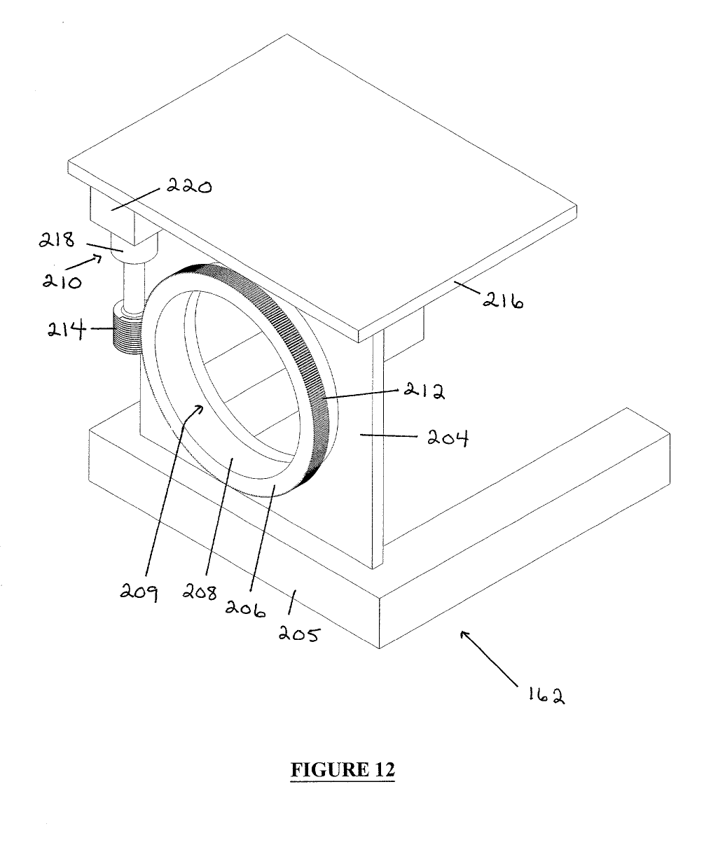

The third indexing mechanism (162) may be comprised of any suitable mechanism, device or structure capable of performing the required function or purpose of the rotating the pipe (22) about its longitudinal axis as described herein. However, referring to FIGS. 11 and 12, in the preferred embodiment, the third indexing mechanism (162) is comprised of an outer plate (204) mounted or fixedly supported by a lower frame member (205) in a desired position adjacent the front end (21) of the apparatus (20). Further, the third indexing mechanism (162) is comprised of a rotatable head (206) rotatably mounted to or within the outer plate (204). The rotatable head (206) releasably secures the pipe (22) such that rotation of the rotatable head (206) rotates the pipe (22) about the pipe longitudinal axis.

In the preferred embodiment, the rotatable head (206) defines an opening (208) for receiving an end of the pipe (22). The pipe (22) may be releasably secured within or to the opening (208) by any suitable fastening or clamping mechanism or device capable of releasably engaging the pipe (22) in a relatively secure manner to permit the rotatable head (206) to rotate the pipe (22). In the preferred embodiment, referring to FIG. 11, the fastening or clamping mechanism is comprised of a hollow spindle chuck (209) positioned or mounted within the opening (208) of the rotatable head (206) for clamping or fastening to the end of the pipe (22). Clamping of the chuck (209) to the end of the pipe (22) securely engages the pipe wall (24), while releasing the clamping of the chuck (209) from the pipe wall (24) permits removal of the end of the pipe (22) therefrom. The chuck (209) is preferably adjustable in order to accommodate varying pipe circumferences.

Referring to FIG. 11, in the preferred embodiment, the chuck (209) includes three jaws (211) spaced about the circumference of the opening (208). Operation of a mechanical screw (213) causes the jaws (211) to extend into the opening (208) to securely engage the pipe wall (24) or to retract from the opening (208) to release the pipe wall (24). The jaws (211) are adjustable in order to accommodate varying pipe circumferences. Further, the engagement end of each jaw (211) may include a plurality of gripping teeth thereon for enhancing the engagement with the pipe surface (24) in the extended position.

The third indexing mechanism (162) may be comprised of any mechanism or device capable of rotating the rotatable head (206) within the outer plate (204). However, preferably, the third indexing mechanism (162) is comprised of a gear assembly (210). Any gear assembly (210) operatively connected with the rotatable head (206) to rotate the rotatable head (206) may be used. However, in the preferred embodiment, the gear assembly (210) is comprised of a worm gear-gear assembly.

More particularly, the rotatable head (206) is preferably comprised of a gear wheel (212) or a worm wheel. Further, the third indexing mechanism (162) is comprised of a worm (214) operatively associated with the gear wheel (212) such that rotation of the worm (214) actuates the gear wheel (212) to cause the rotation of the rotatable head (206) within the outer plate (204). In the preferred embodiment, the worm (214) is mounted or supported in position for engaging the gear wheel (212) by an upper frame member (216) of the third indexing mechanism (162). The upper frame member (216) is mounted or fixedly supported by the outer plate (204).

Thus, the worm (214) drivingly engages the gear wheel (212) such that rotation of the worm (214) actuates the gear wheel (212) to rotate the rotatable head (206). Rotation of the worm (214) in a first direction rotates the rotatable head (206) and thus the pipe (22) in a first direction about the pipe longitudinal axis. Rotation of the worm (214) in an opposed second direction rotates the rotatable head (206) and thus the pipe (22) in an opposed second direction about the pipe longitudinal axis.

Further, the worm (214) is actuated by a gear box (218) and a motor (220). Although any suitable motor (220) may be used, the motor (220) is preferably a variable speed electric motor. In the preferred embodiment, the gear box (218) and the motor (220) are mounted or connected with the upper frame member (216). The preferred embodiment of the gear assembly (210) permits or provides for a controlled, gradual and relatively precise rotational movement of the rotatable head (206) by the third indexing mechanism (162). More particularly, precise controlled rotational movement of the rotatable head (206) by the worm (214) and gear wheel (212) results in precise and consistent or uniform spacing of the slots (30) about the pipe circumference. The particular tolerances between the worm (214) and gear wheel (212) may be selected to minimize backlash and enhance precision indexing of the pipe (22).

As well, the apparatus (20) may include a fourth mechanism (not shown) for rotating the pipe wall (24) about the location of contact between the pipe wall (24) and the cutters (100). For instance, in the preferred embodiment, the location of contact between the pipe (22) and the cutters (100) is along the top dead centre of the pipe (22). Thus, the pipe (22) may be offset a given percentage about the top dead centre of the pipe (22) to allow the cutting of angled straight slots and keystone slots. The fourth mechanism may be comprised of any suitable mechanism, device or structure capable of performing the required function or purpose of rotating the pipe wall (24) about the location of contact between the pipe wall (24) and the cutters (100).

The apparatus (20) is further comprised of a power source (not shown) for driving or operating the various components of the apparatus (20). Specifically, various components of the apparatus (20), such as the clamping system (40), are hydraulically activated. Therefore, the power system or power source is comprised of a hydraulic unit for supplying and circulating oil to the required hydraulic motors and hydraulic cylinders in the apparatus (20), as described above. Further, the apparatus (20) includes a number of electrical motors, as described above. Therefore, the power source is further comprised of a motor control cabinet containing motor controls for operating the various functions of the apparatus (20) such as rpm, penetration rates, cutting rates, clamping and the like., as well as for supplying power to any electrical motors in the apparatus (20).

Finally, the apparatus (20) preferably includes a computer-aided machinery or CAM system which controls the various functions of the apparatus (20). The CAM system includes a computer monitor and control station (not shown) where information and instructions, such as the rpm, penetration rate, running rate, indexing, and the other operations of the apparatus (20), may be entered and monitored. The CAM system will be controlled and programmed by the operator of the apparatus (20). To aid the operator in the use of the CAM system, the monitor and control station of the CAM system is preferably allowed to move along one side of the apparatus (20) to any position. This movement allows the operator to walk along the side of the apparatus (20) with the monitor and control station while viewing the apparatus (20), including the operation of the cutting head (42). In the event of a blade (144) failure or other apparatus (20) breakdown, the operator may slide the monitor and control station to the area requiring work. The operator will thus be able to control and monitor the apparatus (20) at any required location during startup of the apparatus (20), continued operation of the apparatus (20) or shut down.

The invention is further directed at a method for slotting the pipe (22). Preferably, the method is performed utilizing the apparatus (20) as described herein. However, any suitable apparatus capable of performing the method may alternatively be used.

The method is comprised of the step of positioning the pipe (22) on a stationary pipe bed (38) and moving a clamping system (40) associated with the pipe bed (38) to a clamped position to releasably secure the pipe (22) to the pipe bed (38). The clamping system (40) is preferably comprised of a clamping surface (50) adapted to engage the pipe wall (24) in the manner described above for the apparatus (20). Further, the clamping system (40) preferably defines a longitudinal clamping gap (52) in the clamped position oriented to permit the slotting of the pipe (22) therethrough. In the preferred embodiment of the method, the pipe (22) is preferably releasably secured in the clamped position such that the longitudinal axis of the pipe (22) is substantially horizontal.

Further, in the method, the clamping surface (50) is adapted to engage in the clamped position at least about 50 percent of the pipe circumference and at least about 50 percent of the pipe length. The specific percent of the pipe circumference and the pipe length to be engaged by the clamping surface (50) may each be increased above 50 percent as required to securely engage the pipe (22). For instance, the clamping surface (50) may be adapted to engage at least about 70 percent of the pipe circumference in the clamped position or at least about 90 percent of the pipe circumference in the clamped position. In the preferred embodiment, the clamping surface (50) is adapted to engage at least about 95 percent of the pipe circumference in the clamped position. Further, the clamping surface (50) may be adapted to engage at least about 70 percent of the pipe length in the clamped position. In the preferred embodiment, the clamping surface (50) is adapted to engage at least about 90 percent of the pipe length in the clamped position.

The method is further comprised of the step of providing a movable cutting head (42) at a location adjacent to the pipe bed (38). The cutting head (42) is comprised of a plurality of cutters (100) for slotting the pipe (22). Further, the cutters (100) are linearly arranged along the cutting head (42) in a row substantially parallel to the longitudinal clamping gap (52).

In addition, the method is comprised of the step of first moving the cutting head (42) in a direction toward the longitudinal clamping gap (52) to move the cutters (100) into engagement with the pipe wall (24) such that the pipe wall (24) is perforated by the cutters (100) through the longitudinal clamping gap (52) at a location of contact between the cutters (100) and the pipe wall (24). In the preferred embodiment, the first moving step moves the cutting head (42) substantially vertically or in a vertical plane to contact the cutters (100) with the pipe wall (24), preferably such that the location of contact is top dead centre of the pipe (22). Accordingly, the longitudinal clamping gap (52) in the clamped position of the clamping system (40) is positioned or oriented to permit the slotting of the pipe (22) at this preferred location of contact.

The method is then comprised of the step of second moving the cutting head (42) longitudinally relative to the pipe bed (38) along the longitudinal clamping gap (52). The second moving step is performed independently from the first moving step and in sequence following the first moving step. Accordingly, as a result of the second moving step, the perforated pipe wall (24) is further cut by the cutters (100) through the longitudinal clamping gap (52) to form a first plurality of discrete slots (30), each of the slots (30) having a length. In the preferred embodiment, the second moving step moves the cutting head (42) substantially horizontally or in a horizontal plane.

A third moving step of the method moves the cutting head (42) away from the longitudinal clamping gap (52) so that the cutters (100) are moved out of engagement with the pipe wall (24). In the preferred embodiment, the third moving step again moves the cutting head (42) substantially vertically or in a vertical plane to move the cutters (100) out of contact with the pipe wall (24). The clamping system (40) is then moved to an unclamped position from the clamped position.

Once in the unclamped position, the method is further comprised of the step of rotating the pipe (22) about the pipe longitudinal axis. The previously described steps of the method are then repeated including moving the clamping system (40) to the clamped position, providing the movable cutting head (42) at the location adjacent the pipe bed (38), first moving the cutting head (42), second moving the cutting head (42) and third moving the cutting head (42) all in the manner described above. As a result of repeating these steps, a second plurality of discrete slots (30) are formed in the pipe wall (24), wherein the first plurality of discrete slots (30) and the second plurality of discrete slots (30) are spaced circumferentially about the pipe circumference. The method is further repeated until the desired number of rows of discrete slots (30) have been cut about the pipe circumference. The rows of the slots (30) may be cut side by side, staggered or in any other pattern or configuration desired by the operator performing the method.

The embodiments of the invention in which an exclusive property or privilege is claimed are defined as follows:

1. An apparatus for slotting a pipe, the pipe having a pipe length, a pipe wall and a pipe longitudinal axis, the pipe wall having a pipe external surface defining a pipe circumference, the apparatus comprising:
(a) a stationary pipe bed for supporting the pipe, the pipe bed having a pipe bed length;
(b) a clamping system associated with the pipe bed and having a clamp length, the clamping system being movable between a clamped position for releasably securing the pipe to the pipe bed and an unclamped position, wherein the clamping system is comprised of a clamping surface adapted to engage in the clamped position at least about 50 percent of the pipe circumference and at least about 50 percent of the pipe length, and wherein the clamping system in the clamped position defines a longitudinal clamping gap extending along the clamp length which is oriented to permit the slotting of the pipe therethrough;
(c) a movable cutting head located adjacent to the pipe bed, the cutting head comprising a plurality of cutters for slotting the pipe, the cutters linearly arranged along the cutting head in a row substantially parallel to the longitudinal clamping gap;
(d) a first perforating mechanism for moving the cutting head toward and away from the longitudinal clamping gap such that the pipe wall is perforated by the cutters through the longitudinal clamping gap at a location of contact between the cutters and the pipe wall;
(e) a second longitudinal cutting mechanism, operable independently from the first perforating mechanism, for moving the cutting head longitudinally relative to the pipe bed along the longitudinal clamping gap such that the perforated pipe wall is further cut by the cutters through the longitudinal clamping gap to form a plurality of discrete slots, each of the slots having a slot length; and
(f) a third indexing mechanism for rotating the pipe about the pipe longitudinal axis when the clamping system is in the unclamped position, in order to vary the location of contact between the cutters and the pipe wall about the pipe circumference.

2. The apparatus as claimed in claim 1 wherein the clamping surface is adapted to engage at least about 70 percent of the pipe circumference in the clamped position.

3. The apparatus as claimed in claim 2 wherein the clamping surface is adapted to engage at least about 90 percent of the pipe circumference in the clamped position.

4. The apparatus as claimed in claim 1 wherein the clamping surface is adapted to engage at least about 70 percent of the pipe length in the clamped position.

5. The apparatus as claimed in claim 2 wherein the clamping surface is adapted to engage at least about 70 percent of the pipe length in the clamped position.

6. The apparatus as claimed in claim 3 wherein the clamping surface is further adapted to engage at least about 70 percent of the pipe length in the clamped position.

7. The apparatus as claimed in claim 1 wherein the clamping surface is adapted to engage at least about 90 percent of the pipe length in the clamped position.

8. The apparatus as claimed in claim 2 wherein the clamping surface is adapted to engage at least about 90 percent of the pipe length in the clamped position.

9. The apparatus as claimed in claim 3 wherein the clamping surface is adapted to engage at least about 90 percent of the pipe length in the clamped position.

8. The apparatus as claimed in claim 5 wherein the clamping system is comprised of a plurality of clamps which collectively comprise the clamping surface, wherein the clamps are longitudinally spaced along the clamp length for engaging the pipe circumference in the clamped position.

9. The apparatus as claimed in claim 8 wherein each clamp is comprised of a pair of clamp arms and wherein the clamp arms define the longitudinal clamping gap therebetween.

10. The apparatus as claimed in claim 9 wherein at least one of the clamp arms is movable relative to the other clamp arm for moving the clamping system between the clamped position and the unclamped position.

11. The apparatus as claimed in claim 10 wherein the clamping system is further comprised of at least one hydraulic cylinder operatively connected with the movable clamp arms such that actuation of the hydraulic cylinder moves the clamping system between the clamped position and the unclamped position.

12. The apparatus as claimed in claim 5 wherein the third indexing mechanism is comprised of:
(a) a rotatable head for releasably securing the pipe such that rotation of the rotatable head rotates the pipe about the pipe longitudinal axis, wherein the rotatable head is comprised of a gear wheel; and
(b) a worm operatively associated with the gear wheel such that rotation of the worm actuates the gear wheel to rotate the rotatable head.

13. The apparatus as claimed in claim 5 wherein the second longitudinal cutting mechanism is comprised of a rack and worm gear assembly, wherein the rack is operatively connected with the cutting head such that rotation of the worm moves the cutting head relative to the pipe bed along the longitudinal clamping gap.

14. The apparatus as claimed in claim 12 wherein the second longitudinal cutting mechanism is comprised of a rack and worm gear assembly, wherein the rack is operatively connected with the cutting head such that rotation of the worm moves the cutting head relative to the pipe bed along the longitudinal clamping gap.

15. The apparatus as claimed in claim 5 wherein the first perforating mechanism is comprised of:
(a) a movable frame for supporting the cutting head adjacent to the pipe bed such that the row of cutters is movable towards and away from the longitudinal clamping gap in order to move the cutters into and out of contact with the pipe wall;
(b) a carriage for supporting the movable frame, wherein the carriage is movable longitudinally relative to the pipe bed and wherein the carriage is associated with the movable frame such that longitudinal movement of the carriage relative to the pipe bed is translated into movement of the cutters either towards or away from the longitudinal clamping gap; and
(c) a gear assembly comprised of a rack and worm, wherein the rack is operatively connected with the carriage such that rotation of the worm moves the carriage longitudinally relative to the pipe bed.

16. The apparatus as claimed in claim 14 wherein the first perforating mechanism is comprised of:
(a) a movable frame for supporting the cutting head adjacent to the pipe bed such that the row of cutters is movable towards and away from the longitudinal clamping gap in order to move the cutters into and out of contact with the pipe wall;
(b) a carriage for supporting the movable frame, wherein the carriage is movable longitudinally relative to the pipe bed and wherein the carriage is associated with the movable frame such that longitudinal movement of the carriage relative to the pipe bed is translated into movement of the cutters either towards or away from the longitudinal clamping gap; and
(c) a gear assembly comprised of a rack and worm, wherein the rack is operatively connected with the carriage such that rotation of the worm moves the carriage longitudinally relative to the pipe bed.

17. A method for slotting a pipe, the pipe having a pipe length, a pipe wall and a pipe longitudinal axis, the pipe wall having a pipe external surface defining a pipe circumference, the method comprising the steps of:
(a) positioning the pipe on a stationary pipe bed;
(b) moving a clamping system associated with the pipe bed to a clamped position to releasably secure the pipe to the pipe bed, the clamping system comprising a clamp length and a clamping surface, such that the clamping surface engages at least about 50 percent of the pipe circumference and at least about 50 percent of the pipe length, and such that the clamping system defines a longitudinal clamping gap extending along the clamp length which is oriented to permit the slotting of the pipe therethrough;
(c) providing a movable cutting head at a location adjacent to the pipe bed, the cutting head comprising a plurality of cutters for slotting the pipe, the cutters linearly arranged along the cutting head in a row substantially parallel to the longitudinal clamping gap;
(d) first moving the cutting head in a direction toward the longitudinal clamping gap to move the cutters into engagement with the pipe wall such that the pipe wall is perforated by the cutters through the longitudinal clamping gap at a location of contact between the cutters and the pipe wall;
(e) second moving the cutting head longitudinally relative to the pipe bed along the longitudinal clamping gap, wherein the second moving step is performed independently from the first moving step and in sequence following the first moving step, such that the perforated pipe wall is further cut by the cutters through the longitudinal clamping gap to form a first plurality of discrete slots, each of the slots having a length;
(f) third moving the cutting head away from the longitudinal clamping gap so that the cutters are moved out of engagement with the pipe wall;
(g) moving the clamping system to an unclamped position from the clamped position;
(h) rotating the pipe about the pipe longitudinal axis; and
(i) repeating steps (a) through (f) to form a second plurality of discrete slots, wherein the first plurality of discrete slots and the second plurality of discrete slots are spaced circumferentially about the pipe circumference.

18. The method as claimed in claim 17 wherein the clamping surface engages at least about 70 percent of the pipe circumference in the clamped position.

19. The method as claimed in claim 18 wherein the clamping surface engages at least about 90 percent of the pipe circumference in the clamped position.

20. The method as claimed in claim 17 wherein the clamping surface engages at least about 70 percent of the pipe length in the clamped position.

21. The method as claimed in claim 18 wherein the clamping surface engages at least about 70 percent of the pipe length in the clamped position.

22. The method as claimed in claim 19 wherein the clamping surface engages at least about 70 percent of the pipe length in the clamped position.

23. The method as claimed in claim 17 wherein the clamping surface engages at least about 90 percent of the pipe length in the clamped position.

24. The method as claimed in claim 18 wherein the clamping surface engages at least about 90 percent of the pipe length in the clamped position.

25. The method as claimed in claim 19 wherein the clamping surface engages at least about 90 percent of the pipe length in the clamped position.
